(19) United States
(12) Patent Application Publication
(10) Pub. No.: US 2024/0335000 A1
(43) Pub. Date: Oct. 10, 2024

(54) SHOE

(71) Applicant: Shimano Inc., Osaka (JP)

(72) Inventors: Toshiaki AOKI, Osaka (JP); Kaoru OUCHI, Osaka (JP); Kadunori IUCHI, Osaka (JP); Junichi KIKUTA, Osaka (JP)

(21) Appl. No.: 18/132,221

(22) Filed: Apr. 7, 2023

(51) Int. Cl. A43B 5/14; A43B 7/06; B62M 3/08

(52) U.S. Cl. CPC A43B 5/14; A43B 7/06; B62M 3/086

(57) ABSTRACT

A shoe is basically provided with an upper, an inner plate, an outer plate and a first coupling member. The upper has a toe end, a heel end and a bottom portion extending between the toe end and the heel end in a longitudinal direction. The inner plate is removably disposed on an upper side of the bottom portion. The outer plate has a contact portion configured to contact at least one of a cleat and a pedal. The outer plate is disposed on a bottom side of the bottom portion. The first coupling member is configured to couple the inner plate and the outer plate.

### BACKGROUND

### Technical Field

This disclosure generally relates to a shoe. More specifically, the present disclosure relates to a shoe having an upper, an inner plate disposed inside the upper and an outer plate disposed on the bottom side of the upper.

### Background Information

Generally, most shoes have an upper and a sole. The upper is stitched or adhesively bonded to the sole to form an interior foot receiving space for securely receiving a foot. The upper is typically formed from one or more flexible materials such as a textile fabric, a leather, and/or a synthetic leather that are stitched or adhesively bonded together. The upper can also include rigid reinforcements as needed and/or desired. The upper defines an ankle opening for inserting the wearer's foot into the interior foot receiving space and for removing wearer's foot from the interior foot receiving space. In addition, the upper can include a lace or other closure to more securely retain the shoe to the wearer's foot within the interior foot receiving space. The sole can be a single layer made of a suitable material, or can be made of several layers of different materials.

### SUMMARY

Generally, the present disclosure is directed to various features of a shoe.

In view of the state of the known technology and in accordance with a first aspect of the present disclosure, a shoe is provided that basically comprises an upper, an inner plate, an outer plate and a first coupling member. The upper has a toe end, a heel end and a bottom portion extending between the toe end and the heel end in a longitudinal direction. The inner plate is removably disposed on an upper side of the bottom portion. The outer plate has a contact portion configured to contact at least one of a cleat and a pedal. The outer plate is disposed on a bottom side of the bottom portion. The first coupling member is configured to couple the inner plate and the outer plate.

With the shoe according to the first aspect, the shoe can be manufactured at a relatively low cost.

In accordance with a second aspect of the present disclosure, the shoe according to the first aspect is configured so that the outer plate includes an opening for receiving the first coupling member.

With the shoe according to the second aspect, the coupling member can be easily provided between the inner plate and the outer plate via the opening in the outer plate.

In accordance with a third aspect of the present disclosure, the shoe according to the first aspect or the second aspect is configured so that the bottom portion includes a through opening which receives the first coupling member therein.

With the shoe according to the third aspect, the first coupling member pass through the upper for easily attaching the outer plate to the inner plate.

In accordance with a fourth aspect of the present disclosure, the shoe according to any one of the first aspect to the third aspect is configured so that the first coupling member includes a male screw portion, and the inner plate has a female screw portion threadedly engaged with the male screw portion therein.

With the shoe according to the fourth aspect, the inner plate and the outer plate can be reliably attached to the upper and can be reliably removed from the upper.

In accordance with a fifth aspect of the present disclosure, the shoe according to any one of the first aspect to the fourth aspect is configured so that the contact portion includes a ground contact portion.

With the shoe according to the fifth aspect, the shoe can used for both pedaling a human-powered vehicle and for walking.

In accordance with a sixth aspect of the present disclosure, the shoe according to any one of the first aspect to the fifth aspect is configured so that the contact portion includes at least one recess configured to accommodate a cleat securing member of a step-in pedal therein.

With the shoe according to the sixth aspect, the shoe can be reliably used with a step-in pedal.

In accordance with a seventh aspect of the present disclosure, a shoe is provided that basically comprises an upper, an inner plate, an outer plate and a first coupling member. The upper has a toe end, a heel end and a bottom portion extending between the toe end and the heel end in a longitudinal direction. The inner plate is removably disposed on an upper side of the bottom portion. The outer plate has a pedal engagement portion configured to engage a step-in pedal. The outer plate is disposed on a bottom side of the bottom portion. The first coupling member is configured to couple the inner plate and the outer plate.

With the shoe according to the seventh aspect, the shoe can be used with a step-in pedal and manufactured at a relatively low cost.

In accordance with an eighth aspect of the present disclosure, the shoe according to any one of the first aspect to the seventh aspect is configured so that the inner plate includes an air ventilation portion.

With the shoe according to the eighth aspect, air can flow between the inside of the shoe and the outside through the inner plate.

In accordance with a ninth aspect of the present disclosure, the shoe according to the eighth aspect is configured so that the air ventilation portion includes a plurality of air ventilation openings.

With the shoe according to the ninth aspect, air ventilation can be easily obtained between the inside of the shoe and the outside through the inner plate.

In accordance with a tenth aspect of the present disclosure, the shoe according to any one of the first aspect to the ninth aspect further comprises a heel pad coupled to a rear end portion of the inner plate.

With the shoe according to the tenth aspect, the bottom of the upper in the area of the heel can be protected by the heel pad, and the rear end of the shoe can be elevated relative to the front area while walking.

In accordance with an eleventh aspect of the present disclosure, the shoe according to the tenth aspect further comprises a second coupling member configured to couple the inner plate and the heel pad.

With the shoe according to the eleventh aspect, the heel pad can be easily and reliably coupled to the inner plate.

In accordance with a twelfth aspect of the present disclosure, the shoe according to any one of the first aspect to the eleventh aspect is configured so that the bottom portion includes a breathable material.

With the shoe according to the twelfth aspect, the upper has a breathability so that air can easily pass between the inside of the shoe and the outside through the bottom portion of the upper.

In accordance with a thirteenth aspect of the present disclosure, the shoe according to the twelfth aspect is configured so that the breathable material includes a mesh material.

With the shoe according to the thirteenth aspect, air ventilation can be easily obtained between the inside of the shoe and the outside through the bottom portion of the upper.

In accordance with a fourteenth aspect of the present disclosure, the shoe according to any one of the first aspect to the thirteenth aspect is configured so that the inner plate includes a first engagement portion, and the outer plate includes a second engagement portion engaged with the first engagement portion.

With the shoe according to the fourteenth aspect, the inner plate and the outer plate can be more reliably and firmly coupled together.

In accordance with a fifteenth aspect of the present disclosure, the shoe according to any one of the first aspect to the fourteenth aspect is configured so that the inner plate further has a heel support portion disposed on a rear end of the inner plate.

With the shoe according to the fifteenth aspect, the heel of the wearer's foot can be reliably supported by the inner plate.

In accordance with a sixteenth aspect of the present disclosure, the shoe according to any one of the first aspect to the fifteenth aspect further comprises a heel cup disposed on the heel end.

With the shoe according to the sixteenth aspect, the heel of the wearer's foot can be reliably held in the upper.

In accordance with a seventeenth aspect of the present disclosure, an inner plate is provided for a shoe having an upper. The inner plate shoe basically comprises a forefoot part, a hindfoot part and a heel pad. The forefoot part includes a first attachment portion configured to be coupled to an outer plate provided to a bottom side on the upper. The hindfoot part is located rearward of the forefoot part and integrally formed with the forefoot part. The heel pad is configured to be attached to the hindfoot part and projecting from a bottom surface of the hindfoot part. In particular, the inner plate is configured removably disposed on an upper side of a bottom portion of the upper.

With the inner plate according to the seventeenth aspect, the inner plate can be provided to an upper of a shoe for reliably supporting the wearer's foot in the upper.

In accordance with an eighteenth aspect of the present disclosure, an outer plate for is provided for a shoe having an upper. The outer plate comprises a second attachment portion and a contact portion. The second attachment portion is configured to be disposed on a bottom side of a bottom portion of the upper. The second attachment portion is attached to an inner plate provided to an upper side of the bottom portion. The contact portion is configured to contact at least one of a cleat and a pedal.

With the outer plate according to the eighteenth aspect, the outer plate can be provided to an upper of a shoe for reliably contacting at least one of a cleat and a pedal.

In accordance with a nineteenth aspect of the present disclosure, the outer plate according to the eighteenth aspect is configured so that the contact surface includes a ground contact portion.

With the outer plate according to the nineteenth aspect, the outer plate can be used with a shoe for both pedaling a human-powered vehicle and for walking.

In accordance with a twentieth aspect of the present disclosure, the outer plate according to the eighteenth aspect is configured so that the contact surface includes at least one recess configured to accommodate a cleat securing member of a step-in pedal therein.

With the shoe according to the twentieth aspect, the outer plate can be used with a shoe for accommodating a cleat securing member of a step-in pedal.

Also, other objects, features, aspects and advantages of the disclosed shoe will become apparent to those skilled in the art from the following detailed description, which, taken in conjunction with the annexed drawings, discloses preferred embodiments of the shoe.

### BRIEF DESCRIPTION OF THE DRAWINGS

Referring now to the attached drawings which form a part of this original disclosure.

FIG. 1 is an outboard side elevational view of a shoe in accordance with a first embodiment.

FIG. 2 is an outboard side elevational view of the shoe illustrated in FIG. 1 and a step-in pedal in which a cleat has been attached.

FIG. 3 is an outboard side elevational view of the shoe illustrated FIGS. 1 and 2 in which the upper is shown in broken lines.

FIG. 4 is an inboard side elevational view of the shoe illustrated in FIGS. 1 to 3 in which the upper is shown in broken lines.

FIG. 5 is a bottom plan view of the shoe illustrated in FIGS. 1 to 4.

FIG. 6 is a bottom plan view of the shoe illustrated in FIGS. 1 to 5, where the outer plate and the heel pad have been removed.

FIG. 7 is a top perspective view of the inner plate, the outer plate and the heel pad illustrated in FIGS. 3 and 4 for the shoe illustrated in FIGS. 1 to 5.

FIG. 8 is a top plan view of the inner plate, the outer plate and the heel pad illustrated in FIG. 7, where the upper has been omitted.

FIG. 9 is a bottom plan view of the inner plate, the outer plate and the heel pad illustrated in FIGS. 7 and 8, where the upper has been omitted.

FIG. 10 is an exploded, top perspective view of the inner plate, the outer plate and the heel pad illustrated in FIGS. 7 to 9, where the upper has been omitted.

FIG. 11 is an exploded, bottom perspective view of the inner plate, the outer plate and the heel pad illustrated in FIGS. 7 to 10, where the upper has been omitted.

FIG. 12 is an enlarged cross sectional view of the shoe illustrated in FIGS. 1 to 5 as seen along section line 12-12 of FIG. 8 in which the upper has been added in between the inner plate and the outer plate.

FIG. 13 is an enlarged cross sectional view of the shoe illustrated in FIGS. 1 to 5 as seen along section line 13-13 of FIG. 8 in which the upper has been added in between the inner plate and the outer plate.

FIG. 14 is a top plan view of the inner plate for the shoe illustrated in FIGS. 1 to 5.

FIG. 15 is a bottom plan view of the inner plate illustrated in FIG. 14 for the shoe illustrated in FIGS. 1 to 5.

FIG. 16 is a bottom perspective view of the inner plate, the outer plate and the heel pad illustrated in FIGS. 7 to 10, where the upper has been omitted and a cleat has been attached to the inner plate and the outer plate.

FIG. 17 is an outboard side elevational view of a step-in pedal and a shoe in accordance with a second embodiment.

FIG. 18 is a bottom plan view of the shoe illustrated in FIG. 17.

FIG. 19 is a top perspective view of the inner plate, the outer plate and the heel pad for the shoe illustrated in FIGS. 17 and 18, where the upper has been omitted.

FIG. 20 is an exploded, top perspective view of the inner plate, the outer plate and the heel pad illustrated in FIG. 19, where the upper has been omitted.

FIG. 21 is an exploded, bottom perspective view of the inner plate, the outer plate and the heel pad illustrated in FIGS. 19 and 20, where the upper has been omitted.

FIG. 22 is an outboard side elevational view of a shoe in accordance with a third embodiment.

FIG. 23 is a bottom plan view of the shoe illustrated in FIG. 22.

FIG. 24 is a bottom plan view of the shoe illustrated in FIGS. 22 and 23, where the outer plate and the heel pad have been removed.

FIG. 25 is a top perspective view of the inner plate, the outer plate and the heel pad for the shoe illustrated in FIGS. 22 and 23, where the upper has been omitted.

FIG. 26 is an exploded, top perspective view of the inner plate, the outer plate and the heel pad illustrated in FIG. 25, where the upper has been omitted.

FIG. 27 is an exploded, bottom perspective view of the inner plate, the outer plate and the heel pad illustrated in FIGS. 25 and 26, where the upper has been omitted.

FIG. 28 is a bottom perspective view of the inner plate, the outer plate and the heel pad illustrated in FIGS. 25 to 27 in which a cleat has been attached to the inner plate and the outer plate.

FIG. 29 is an outboard side elevational view of a shoe in accordance with a fourth embodiment.

FIG. 30 is a bottom plan view of the shoe illustrated in FIG. 29.

FIG. 31 is a top perspective view of the inner plate, the outer plate and the heel pad for the shoe illustrated in FIGS. 29 and 30, where the upper has been omitted.

FIG. 32 is a bottom plan view of the shoe illustrated in FIGS. 29 and 30 where a step-in pedal is engaged with the inner plate.

FIG. 33 is an outboard side elevational view of a shoe in accordance with a fifth embodiment.

FIG. 34 is a bottom plan view of the shoe illustrated in FIG. 33.

FIG. 35 is a top perspective view of the inner plate, the outer plate and the heel pad for the shoe illustrated in FIGS. 33 and 34, where the upper has been omitted.

FIG. 36 is an exploded, top perspective view of the inner plate, the outer plate and the heel pad for the shoe illustrated in FIGS. 33 and 34, where the upper has been omitted.

FIG. 37 is an exploded, bottom perspective view of the inner plate, the outer plate and the heel pad illustrated in FIGS. 35 and 36, where the upper has been omitted.

### DETAILED DESCRIPTION

Selected embodiments will now be explained with reference to the drawings. It will be apparent to those skilled in the shoe field from this disclosure that the following descriptions of the embodiments are provided for illustration only and not for the purpose of limiting the invention as defined by the appended claims and their equivalents.

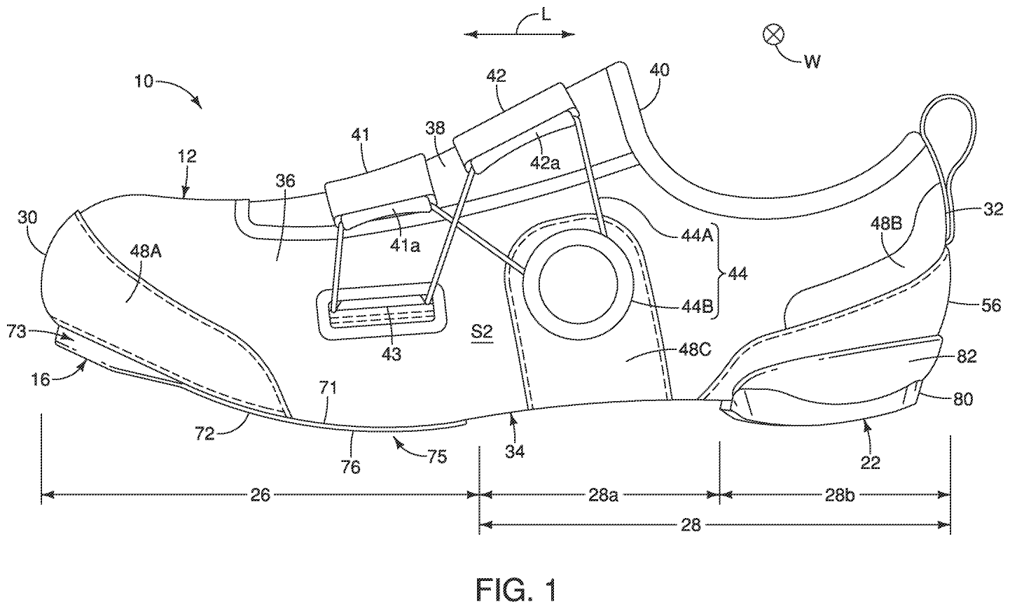

Referring initially to FIGS. 1 to 5, a shoe 10 is illustrated in accordance with a first embodiment of the present disclosure. The shoe 10 is a left shoe of a pair of left-right symmetric ones, in which the right shoe is omitted. The right shoe is identical to the shoe 10 (the left shoe), except that the right shoe is a mirror image of the shoe 10 (the left shoe). Accordingly, description of the shoe 10 applies equally to the right shoe. Therefore, a description will be provided for only one of the shoes (the left shoe 10). The shoe 10 is especially suitable for cycling or other human-powered vehicles having pedals. However, the shoe 10 can be used for other activities other than cycling and pedaling human-powered vehicles.

It should be understood from the drawings and the description herein that the terms “inner side” and “inboard side” refer to the right side of a shoe for the left foot, and the left side of a shoe for the right foot. In other words, the inner side or the inboard side is the side of the shoe facing the shoe on the other foot of the wearer. Similarly, the terms “outer side” and “outboard side” refer to the left side of the shoe for the left foot and the right side of the shoe for the right foot. The outer side or the outboard side is the side of the shoe facing away from the shoe on the other foot. Also, the terms “inner side” and “inboard side” are used interchangeably with respect to the present disclosure. Similarly, the terms “outer side” and “outboard side” are also used interchangeably with respect to the description of the present disclosure.

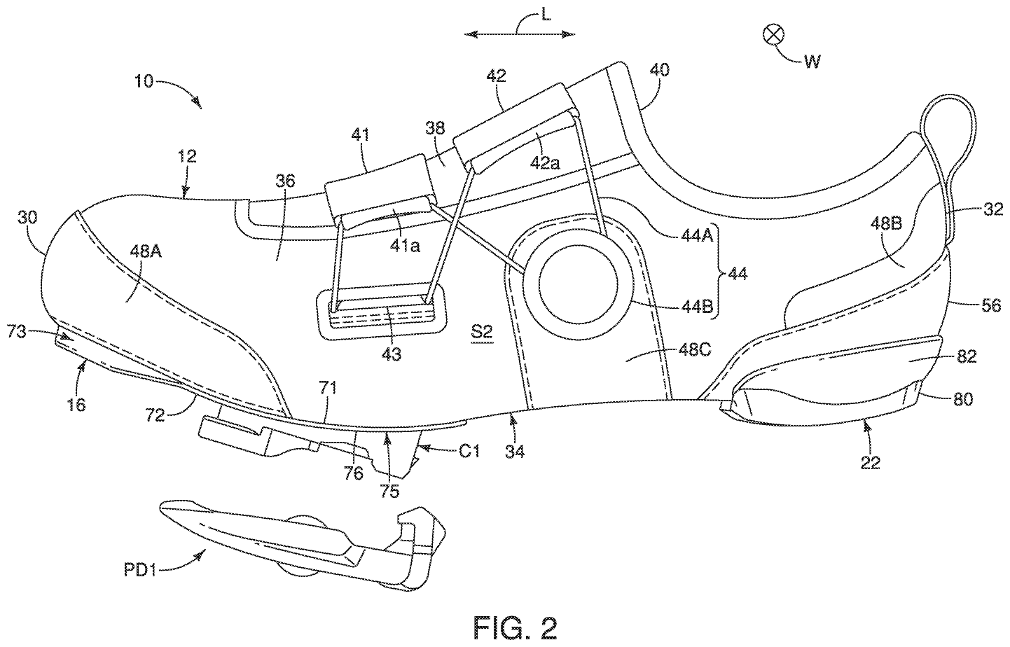

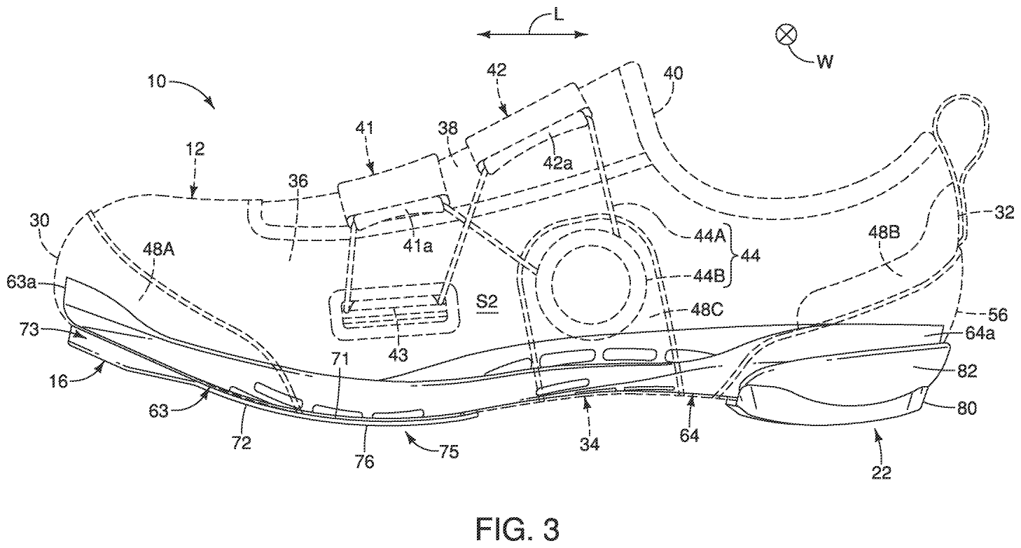

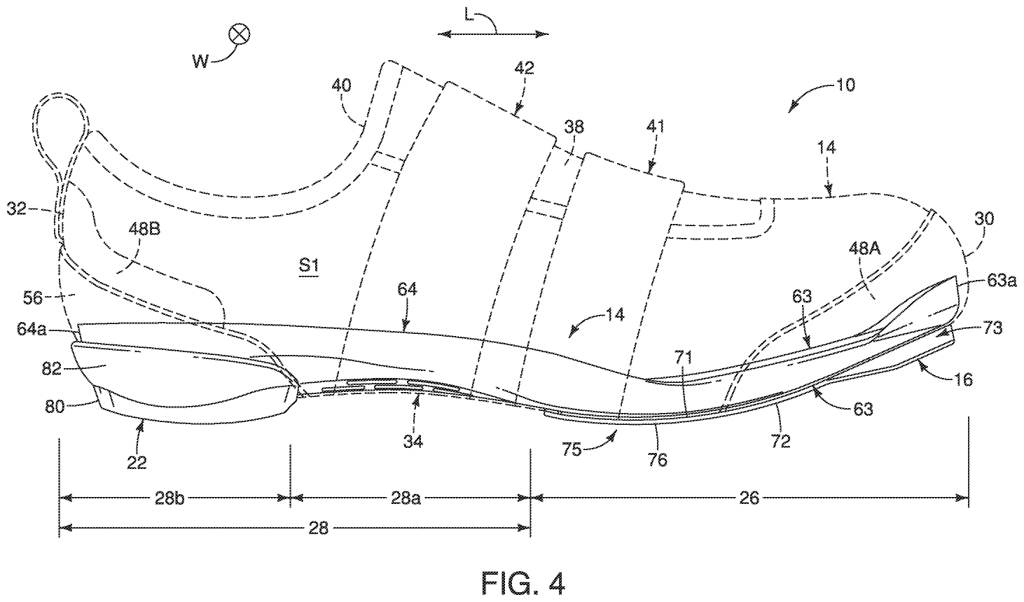

As seen in FIG. 2, a cleat C1 is attached to the shoe 10 so that the shoe can be attached to the step-in pedal PD1. As seen in FIGS. 3 and 4, the shoe 10 basically comprises an upper 12, an inner plate 14 and an outer plate 16. The inner plate 14 and the outer plate 16 are configured to be attached to the upper 12. In this way, the cleat C1 can be attached to the upper 12 via the inner plate 14 and the outer plate 16. Thus, in the illustrated embodiment, the upper 12, the inner plate 14 and the outer plate 16 are especially useful for cycling.

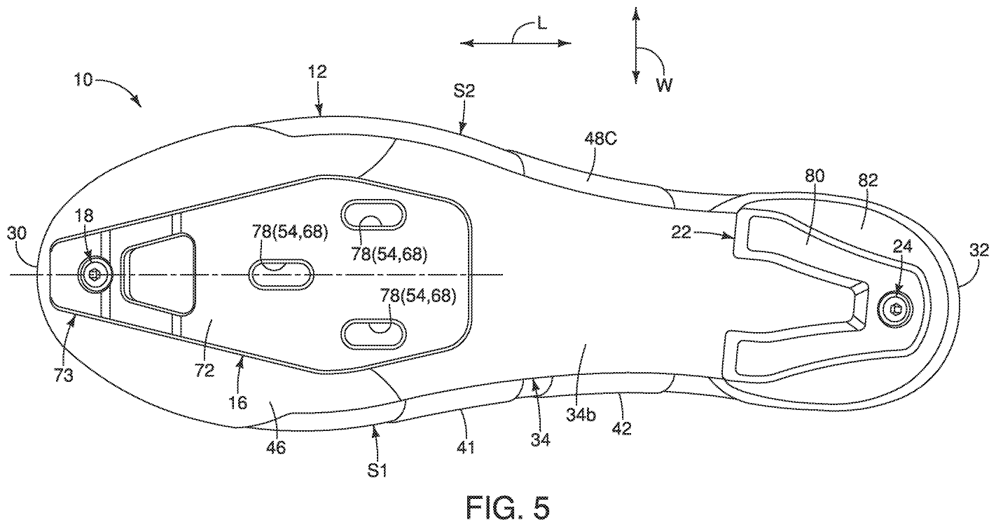

Basically, the inner plate 14 and the outer plate 16 form a sole to support a wear's foot in the upper 12. Specifically, as seen in FIG. 5, the plate 14 and the outer plate 16 are attached to the upper 12. For example, the shoe 10 further comprises a first coupling member 18. While only the first coupling member 18 is used in the illustrated embodiments, the shoe 10 can include more than one first coupling member. Moreover, when more than one first coupling member is used, the first coupling members can be the same or different. The first coupling member 18 is configured to couple the inner plate 14 and the outer plate 16. Here, the first coupling member 18 includes a male screw portion 18a. The first coupling member 18 also includes a head portion 18b. For example, the first coupling member 18 is a fixing bolt that is removable from the outer plate 16. On the other hand, the inner plate 14 has a female screw portion 20 threadedly engaged with the male screw portion 18a therein. Here, the female screw portion 20 is nut that is provided to the inner plate 14. Alternatively, the female screw portion 20 can be a hole having an internal thread that is integrally formed in the inner plate 14, or an inset part that molded into the inner plate 14. Thus, the inner plate 14 is for the shoe 10 having the upper 12. Thus, the outer plate 16 is for the shoe 10 having the upper 12.

In the illustrated embodiment, as seen in FIGS. 1 to 5, the shoe 10 further comprises a heel pad 22 coupled to a rear end portion of the inner plate 14. The heel pad 22 can also be referred to as a heel support portion 22. In other words, the inner plate 14 further has the heel support portion 22 disposed on a rear end portion of the inner plate 14. Here, for example, as seen in FIG. 5, the shoe 10 further comprises a second coupling member 24 that is configured to couple the inner plate 14 and the heel pad 22. While only the second coupling member 24 is used in the illustrated embodiments, the shoe 10 can include more than one second coupling member. Moreover, when more than one second coupling member is used, the second coupling members can be the same or different. The second coupling member 24 is configured to couple the heel pad 22 to the inner plate 14 with the upper 12 disposed therebetween. Here, the second coupling member 24 includes a male screw portion 24a. The second coupling member 24 also includes a head portion 24b. For example, the second coupling member 24 is a fixing bolt that is removable from the heel pad 22. On the other hand, the inner plate 14 has a female screw portion 25 threadedly engaged with the male screw portion 24a therein. Here, the female screw portion 25 is nut that is provided to the inner plate 14. Alternatively, the female screw portion 25 can be a hole having an internal thread that is integrally formed in the inner plate 14, or an inset part that molded into the inner plate 14.

Referring back to FIG. 1, the shoe 10 includes a forefoot portion 26 and a tarsal part 28. The tarsal part 28 of the shoe 10 can be further subdivided into a midfoot part 28a and a hindfoot portion 28b. Basically, the bones of a person's foot can be divided into three groups (i.e., the phalanges, the metatarsals and the tarsals. In describing the shoe 10, the term “forefoot portion” as used herein refers the portion or part of the shoe sole that supports the phalanges and the metatarsals of the person's foot, while the term “tarsal part” as used herein refers the portion or part of the shoe sole that supports the tarsals of the person's foot. The tarsals of the foot are organized into three groups: proximal, intermediate, and distal. The proximal group includes the tarsal bones that include the talus and the calcaneus. The intermediate group contains one bone, the navicular. The distal group includes the cuboid and the three cuneiforms. The term “midfoot part” as used herein refers the portion or part of the shoe sole that supports the navicular, cuboid, and cuneiforms of the person's foot, while the term “hindfoot portion” as used herein refers the portion or part of the shoe sole that supports the talus and calcaneus of the person's foot. The “hindfoot portion” can also be referred to as the heel part.

Here, as seen in FIGS. 1 and 2, the upper 12 is a low-cut style of upper. However, the upper 12 is not limited to the low-cut style, but maybe any style as needed and/or desired. The upper 12 has a toe end 30, a heel end 32 and a bottom portion 34. The bottom portion 34 extends between the toe end 30 and the heel end 32 in a longitudinal direction L. The upper 12 includes further a body portion 36 coupled to the bottom portion 34. For example, the body portion 36 is sewn to the bottom portion 34. The upper 12 includes further a tongue portion 38 coupled to the body portion 36 between the lateral sides of the body portion 36. The body portion 36 and the tongue portion 38 define a foot receiving opening 40 for a receiving a wearer's foot.

Here, as seen in FIGS. 1 to 4, the upper 12 further includes a first strap 41, a second strap 42, a shoelace guide 43 and a fastening structure 44 (i.e., a closure) for tightening and securing the shoe 10 to a wearer's foot. For example, the fastening structure 44 includes a shoelace 44A and a shoelace tightener 44B. The shoelace tightener 44B is a reel based tightener that is coupled to the shoelace 44A for tightening and loosening the shoelace 44A with respect to the upper 12. Of course, it will be apparent that other types of reel based tighteners as well as non-reel based tighteners can be used for tightening and securing the shoe 10 to a wearer's foot as needed and/or desired.

Basically, the first strap 41 and the second strap 42 extend in a widthwise direction W of the shoe 10. The widthwise direction W is indicated by the symbol “⊗” in FIGS. 1 to 4 The first strap 41 has one end attached to a first lateral side S1 of the upper 12, and includes a shoelace guide 41a at the other end for receiving the shoelace 44A therethrough. Also, the second strap 42 has one end attached to the first lateral side S1 of the upper 12, and includes a shoelace guide 42a at the other end for receiving the shoelace 44A therethrough. The shoelace guide 43 is attached to the upper 12 on a second lateral side S2 of the upper 12, where the second lateral side S2 is opposite to the first lateral side S1 where the ends of the first strap 41 and the second strap 42 are attached to the upper 12. The shoelace tightener 44B is also attached to the upper 12 on the second lateral side S2 of the upper 12. The shoelace tightener 44B is configured to pull the shoelace 44A to tighten the shoe 10 on a wearer's foot, and to loosen the shoelace 44A to loosen the shoe 10 on a wearer's foot in a conventional manner. Alternatively, the fastening structure 44 can include only a shoelace. Also, alternatively, the upper 12 can include one or more fixing straps having a hook and loop fastener attachment with fabric hook and loop fastening materials. Since fastening structures for securing a shoe to a wearer's foot are conventional and well-known structures, a detailed description of the fastening structures are omitted for the sake of brevity.

The upper 12 can be made of any suitable natural or polymetric materials. The upper 12 can be formed of an expandable material or a non-expandable material. For example, the upper 12 can be made of a leather material, a nylon mesh and/or any other material that is utilized for conventional uppers. Alternatively, the upper 12 can be made of a stretchable material or stretchable fabric which has the ability to stretch and elastically return to an original unstretched state. For example, the stretchable material can be partially made of elastic fibers, such as Lycra, Spandex or elastane, and/or can be a knit fabric which stretches due to a series of interlocking loops formed in the production of the upper 12.

Here, the upper 12 is primarily constructed of a breathable mesh material that is reinforced at selected locations with a reinforcement layer or strip such as a leather strip. For example, in the illustrated embodiment, the bottom portion 34 includes a breathable material. Also, for example, the breathable material includes a mesh material. Here, a reinforcing layer 46 is provided to the bottom portion 34 in the forefoot portion 26 of the shoe 10. In particular, as seen in FIG. 4, the reinforcing layer 46 is a U-shaped layer that overlies the mesh material of the bottom portion 34. Likewise, the body portion 36 includes a breathable material such as a mesh material. The mesh material of the body portion 36 is coupled to the bottom portion 34 and the tongue portion 38 to form as a low-cut sock or a no-show sock. The mesh material of the body portion 36 can be the same as the mesh material of the bottom portion 34. Alternatively, the mesh material of the body portion 36 can be different from the mesh material of the bottom portion 34. The tongue portion 38 is preferably formed of a more stretchable material than the mesh material of the bottom portion 34 and the mesh material of the body portion 36.

Referring to FIGS. 1 to 4, here, the upper 12 has a reinforcing layer 48A that is provided to a toe portion of the body portion 36. Also, the upper 12 has a reinforcing layer 48B that is provided to a heel portion of the body portion 36. Moreover, the upper 12 has a reinforcing layer 48C that is provided to the second lateral side S2 of the upper 12 at a midfoot portion. The shoelace tightener 44B is also attached to the upper 12 at the reinforcing layer 48C. In the illustrated embodiment, the reinforcing layers 48A, 48B and 48C are leather strips that are sewn onto the upper 12 and/or adhesively bonded to the upper 12.

Since the present disclosure is applicable to a variety of differing shoe styles, designs and configuration, the depicted embodiment of the upper 12 shows a basic shoe design that is made of several textile based materials that are sewn or stitched together to form the depicted shape. However, the upper 12 of the present disclosure is not limited to the depicted shape and/or the depicted materials, as will be understood from the description of the shoe 10 of the present disclosure.

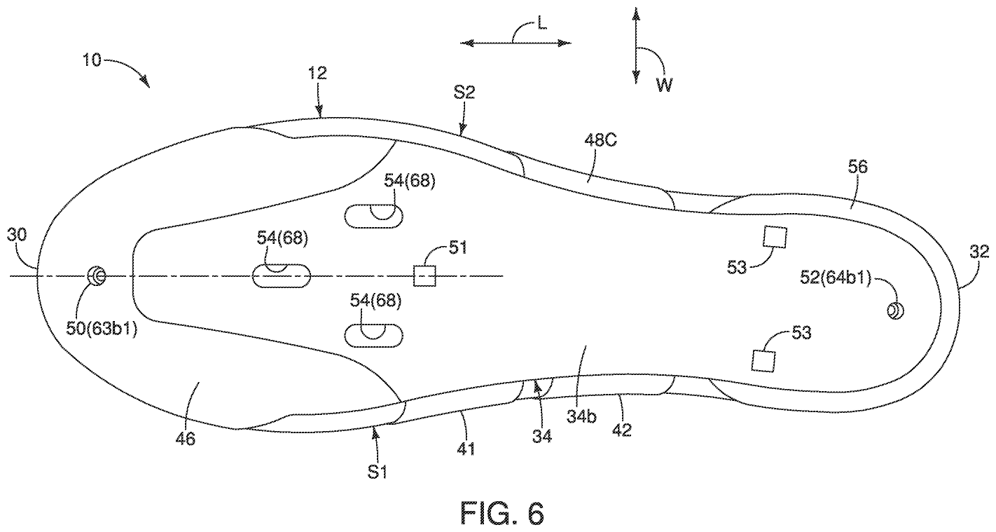

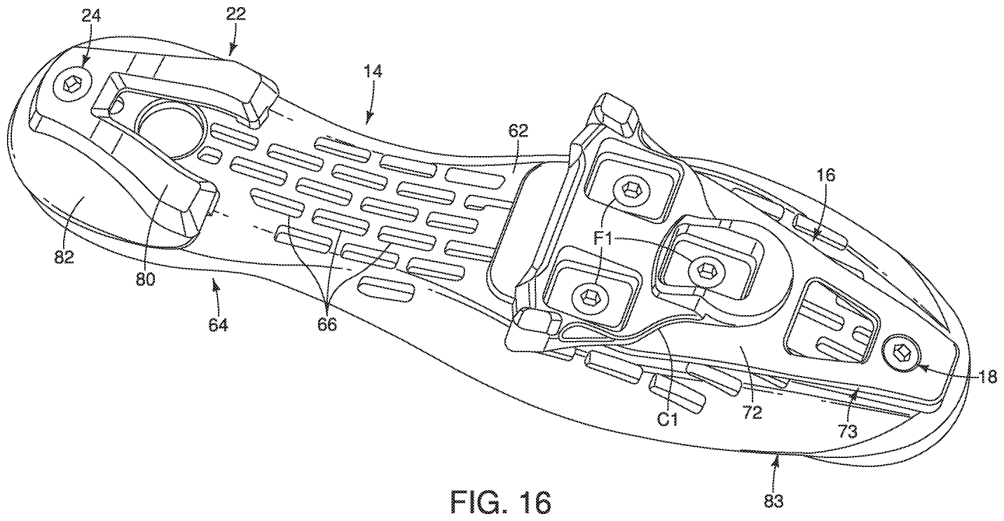

Referring to FIG. 6, the bottom portion 34 will be discussed in more detail. For attaching the outer plate 16 to the inner plate 14 and the upper 12, the bottom portion 34 includes a through opening 50 which receives the first coupling member 18 therein. Also, for attaching the outer plate 16 to the inner plate 14 and to the upper 12, the bottom portion 34 includes a through opening 51 receives a portion of the outer plate 16 therethrough. For attaching the heel pad 22 to the inner plate 14 and the upper 12, the bottom portion 34 includes a through opening 52 which receives the second coupling member 24 therein. Also, for attaching the heel pad 22 to the inner plate 14 and the upper 12, the bottom portion 34 includes a pair of through openings 53 that each receives a portion of the outer plate 16 therethrough. Finally, as seen in FIG. 16, the bottom portion 34 includes a plurality of attachment openings 54 for fasteners F1 (FIG. 16) to attach a cleat C1 to the shoe 10.

Here, as seen in FIGS. 1 to 4, the shoe 10 further comprises a heel cup 56 disposed on the heel end 32 of the upper 12. The heel cup 56 is made of a rigid material such as a thermoplastic polyurethane, or a polyamide resin (e.g., Nylon™). The heel cup 56 is attached to the upper 12. For example, the heel cup 56 is sewn onto the upper 12 and/or adhesively bonded to the upper 12. Here, the heel cup 56 is attached to the reinforcing layer 48B that is provided to the heel portion of the body portion 36.

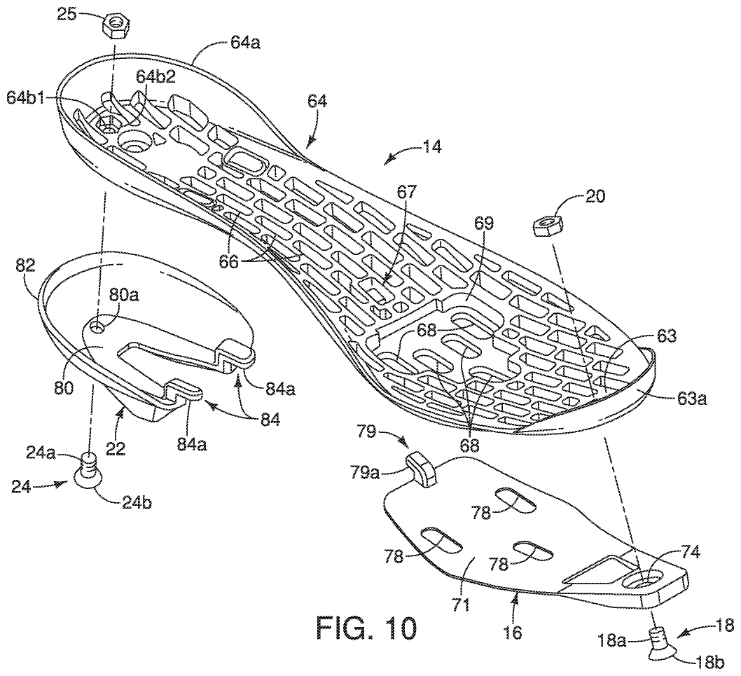

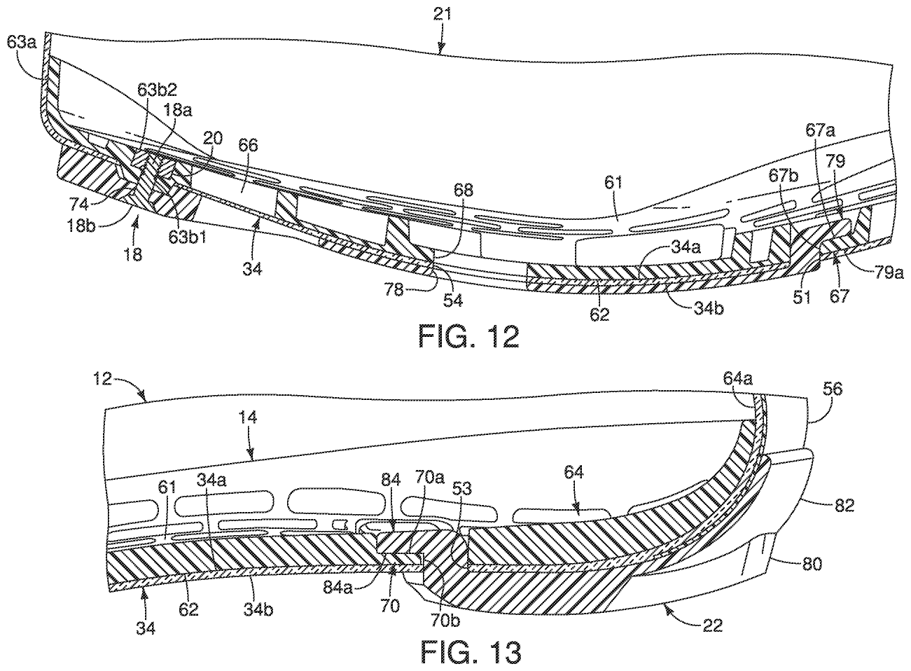

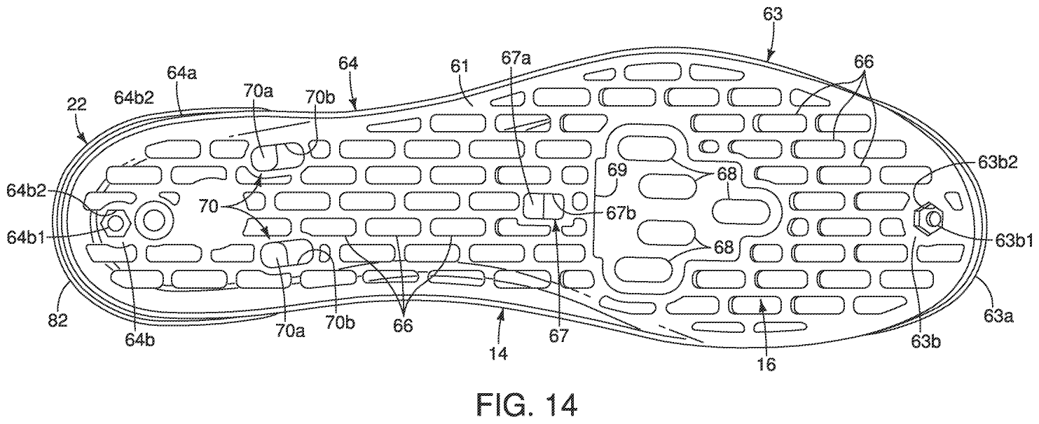

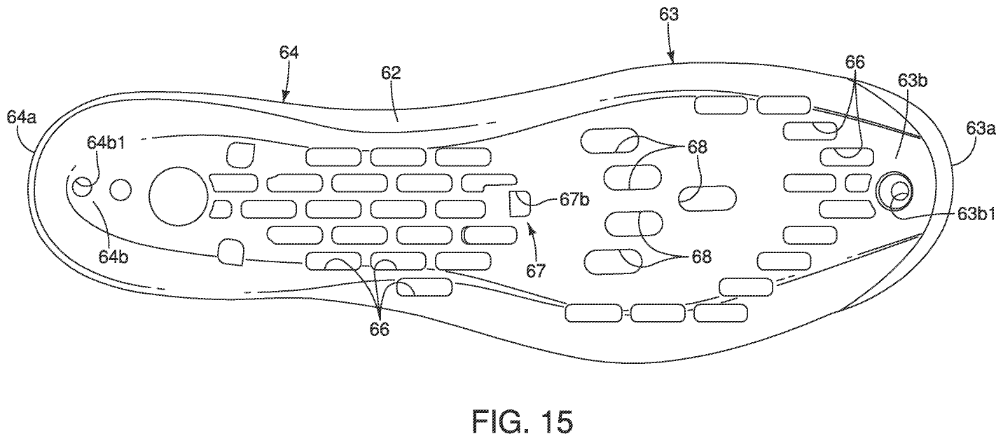

Now, referring to FIGS. 10 to 15, the inner plate 14 will be discussed in more detail. The inner plate 14 can also be called a midsole. Basically, as seen in FIGS. 14 and 15, the inner plate 14 is a one-piece member that is constructed of a substantially rigid material. The inner plate 14 can be formed by molding. In the illustrated embodiments, the inner plate 14 includes a resin material. Preferably, the resin material of the inner plate 14 includes a polyamide material. Also, preferably, the resin material of the inner plate 14 also includes a fiber material. For example, the fiber material includes a plurality of carbon fibers. Thus, for example, the material of the inner plate 14 can be a polyamide material that is reinforced with carbon fibers. Alternatively, for example, the fiber material includes a plurality of glass fibers. Thus, for example, the material of the inner plate 14 can be a polyamide material that is reinforced with glass fibers. In other words, the material of the inner plate 14 can be a fiber reinforced plastic (FRP). By forming the inner plate 14 of a rigid resin material, the inner plate 14 will not deform (e.g., bend) during flexing of the shoe 10 such as during walking, jogging, running, etc.

The inner plate 14 has an upper surface 61 and a bottom surface 62 that facings in the opposite direction to the upper surface 61. The inner plate 14 is removably disposed on an upper side 34a of the bottom portion 34. In other words, the inner plate 14 is inserted inside the upper 12 and overlies the upper side 34a of the bottom portion 34 of the upper 12. A cushion layer or insole can be on the upper surface of the inner plate 14. The inner plate 14 comprises a forefoot portion 63 and a hindfoot portion 64. The inner plate 14 comprises the heel pad 22. As mentioned above, the heel pad 22 (i.e., the heel support portion) is removably attached to the underside of the hindfoot portion 64 of the inner plate 14 by the second coupling member 24.

The forefoot portion 63 includes a toe portion 63a. The toe portion 63a is a curved member that projects up from the upper surface 61 of the inner plate 14. The toe portion 63a is a curves along the peripheral edge the forefoot portion 63 of the inner plate 14. The forefoot portion 63 includes a first attachment portion 63b. The first attachment portion 63b is configured to be coupled to the outer plate 16 that is provided to a bottom side on the upper 12. Here, the first attachment portion 63b includes a first attachment opening 63b1 extending through the forefoot portion 63 of the inner plate 14. Also, here, the first attachment portion 63b includes a first attachment recess 63b2 provided in the upper surface 61 of the inner plate 14 surrounding the first attachment opening 63b1. The first attachment recess 63b2 is shaped to receive the female screw portion 20.

The hindfoot portion 64 includes a heel portion 64a. The heel portion 64a is a curved member that projects up from the upper surface 61 of the inner plate 14. The heel portion 64 is a curves along the peripheral edge the hindfoot portion 64 of the inner plate 14. The hindfoot portion 64 is located rearward of the forefoot portion 63 and integrally formed with the forefoot portion 63. The heel pad 22 is configured to be attached to the hindfoot portion 64 and projects from a bottom surface of the hindfoot portion 64. In particular, the inner plate 14 is configured removably disposed on an upper side of the bottom portion 34 of the upper 12. The hindfoot portion 64 includes a heel pad attachment portion 64b. The heel pad attachment portion 64b is configured to be coupled to the heel pad 22 that is provided to a bottom side on the upper 12. Here, the heel pad attachment portion 64b includes an attachment opening 64b1 extending through the hindfoot portion 64 of the inner plate 14. Also, here, the attachment portion 64b includes an attachment recess 64b2 provided in the upper surface 61 of the inner plate 14 surrounding the attachment opening 64b1. The first attachment recess 64b2 is shaped to receive the female screw portion 25.

Here, the inner plate 14 includes an air ventilation portion 66. For example, in the illustrated embodiment, the air ventilation portion 66 includes a plurality of air ventilation openings 66a. In the illustrated embodiment, the air ventilation openings 66a are elongated slots. However, the air ventilation openings 66a can have other configurations. Moreover, the number of the air ventilation openings 66a can be varied as needed and/or desired.

As seen in FIGS. 10 to 12, to aid in attachment of the inner plate 14 to the outer plate 16, the inner plate 14 includes a first engagement portion 67. The first engagement portion 67 is configured to be engaged with the outer plate 16 to aid in retaining the outer plate 16 to the inner plate 14. Here, the first engagement portion 67 includes a first engagement surface 67a and a first engagement opening 67b. The first engagement surface 67a faces in a direction away from the bottom portion 34 of the upper 12. The first engagement opening 67b is adjacent to the first engagement surface 67a, which is recessed from the upper surface 61 of the inner plate 14.

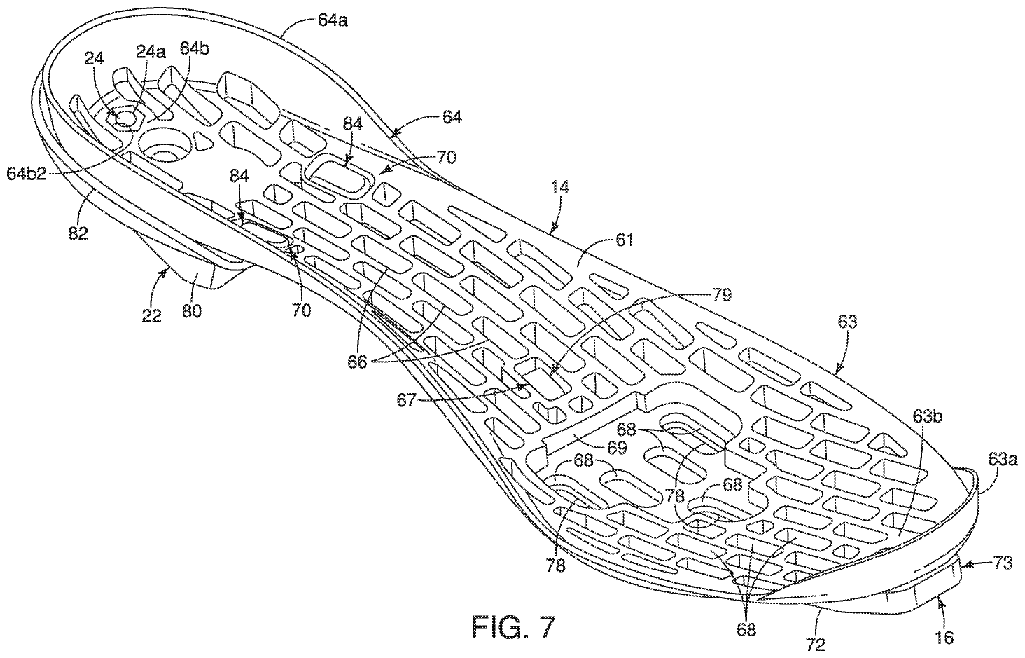

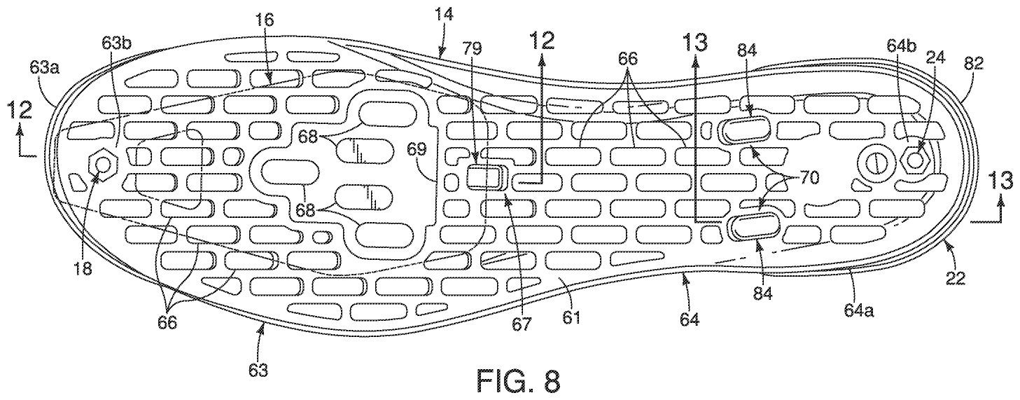

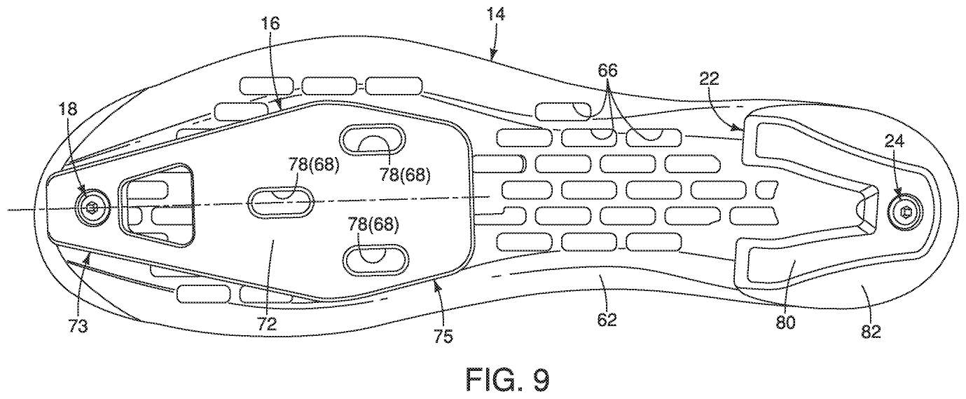

As seen in FIGS. 7, 8 and 14, the inner plate 14 includes a plurality of cleat engagement openings 68. The cleat engagement openings 68 can be slots as in the illustrated embodiment. Alternatively, the cleat engagement openings 68 can be circular holes. Here, the inner plate 14 includes five of the cleat engagement openings 68 such that the inner plate 14 can be used with different types of cleats. Thus, the arrangement of the cleat engagement openings 68 will depend upon the type of cleat that will be used with the shoe 10. Also, preferably the inner plate 14 includes a cleat attachment recess 69 that surrounds the cleat engagement openings 68. In this way, the fasteners of the cleat will not protrude above the upper surface 61 of the inner plate 14.

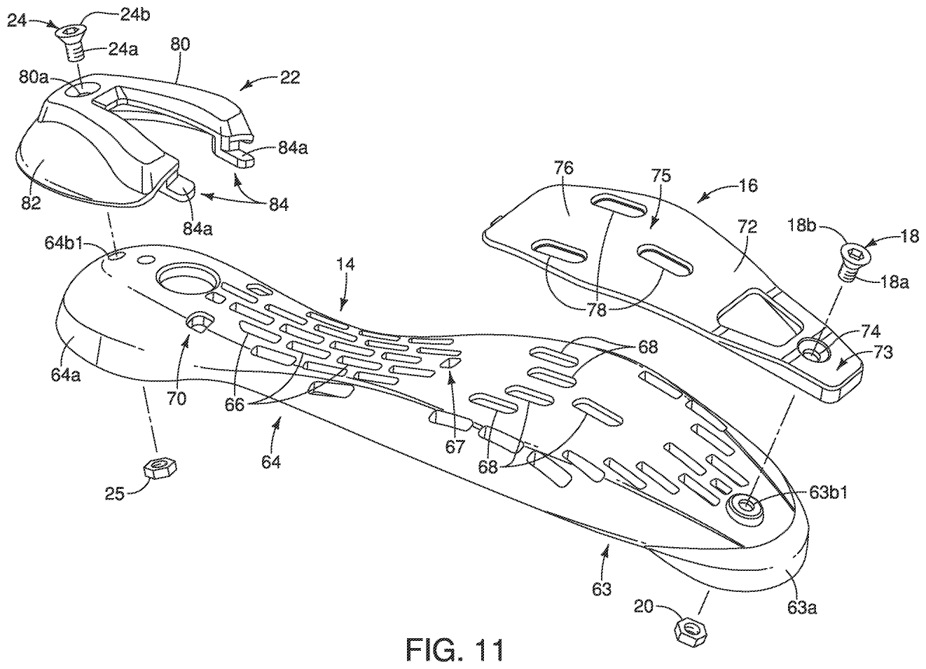

As seen in FIGS. 11 and 13, to aid in attachment of the heel pad 22 to the inner plate 14, the inner plate 14 includes a pair of engagement portions 70. The engagement portions 70 are configured to be engaged with the heel pad 22 to aid in retaining the heel pad 22 to the inner plate 14. Here, each of the engagement portions 70 includes an engagement surface 70a and a first engagement opening 70b. The engagement surface 70a faces in a direction away from the bottom portion 34 of the upper 12. The engagement opening 70b is adjacent to the engagement surface 70a, which is recessed from the upper surface 61 of the inner plate 14.

Now, the outer plate 16 will be discussed in more detail. The outer plate 16 can also be called an outer sole. Basically, the outer plate 16 is a one-piece member that is constructed of a substantially rigid material. In the illustrated embodiments, the outer plate 16 includes a resin material. The outer plate 16 can be formed by molding. Preferably, the resin material of the outer plate 16 includes a polyamide material. Also, preferably, the resin material of the outer plate 16 also includes a fiber material. For example, the fiber material includes a plurality of carbon fibers. Thus, for example, the material of the outer plate 16 can be a polyamide material that is reinforced with carbon fibers. Alternatively, for example, the fiber material includes a plurality of glass fibers. Thus, for example, the material of the outer plate 16 can be a polyamide material that is reinforced with glass fibers. In other words, the material of the outer plate 16 can be a fiber reinforced plastic (FRP). By forming the outer plate 16 of a rigid resin material, the outer plate 16 will not deform (e.g., bend) during flexing of the shoe 10 such as during walking, jogging, running, etc.

The outer plate 16 has an upper surface 71 and a bottom surface 72 that facings in the opposite direction to the upper surface 71. The outer plate 16 is disposed on a bottom side 34b of the bottom portion 34. In particular, the outer plate 16 is removably coupled to the bottom side 34b of the bottom portion 34 by the first coupling member 18. The outer plate 16 further comprises a second attachment portion 73. The second attachment portion 73 is configured to be disposed on the bottom side 34b of the bottom portion 34 of the upper 12. The second attachment portion 73 is attached to the inner plate 14 that is provided to the upper side of the bottom portion 34. Here, the second attachment portion 73 includes an opening 74. Thus, the outer plate 16 includes the opening 74 for receiving the first coupling member 18. In this way, the outer plate 16 is removably coupled to the bottom side 34b of the bottom portion 34 by the first coupling member 18.

The outer plate 16 further comprises a contact portion 75. Basically, the contact portion 75 is configured to contact at least one of a cleat and a pedal. In this first embodiment, the contact portion 75 includes a contact surface 76 and a plurality of cleat attachment openings 78. The contact portion 75 is a slightly curved surface or a relatively flat surface that that is configured to contact a non-clipless pedal, or a cage of a clipless pedal. The contact portion 75 is configured to contact a cleat when a cleat is attached to the outer plate 16. The cleat engagement openings 78 can be slots as in the illustrated embodiment. Alternatively, the cleat engagement openings 78 can be circular holes. Here, the outer plate 16 includes three of the cleat engagement openings 78 such that the inner plate 14. However, the arrangement of the cleat engagement openings 78 will depend upon the type of cleat that will be used with the shoe 10.

As seen in FIGS. 7, 8, 12 and 13, in the assembled state, the outer plate 16 includes a second engagement portion 79 that is engaged with the first engagement portion 67. The second engagement portion 79 is configured to be engaged with the first engagement portion 67 of the inner plate 14 to aid in retaining the outer plate 16 to the inner plate 14. Here, the second engagement portion 79 is a hook shaped member. The second engagement portion includes a second engagement surface 79a. The second engagement surface 79a faces in a direction towards the bottom portion 34 of the upper 12. Thus, the second engagement surface 79a contacts the first engagement surface 64a to retain the outer plate 16 to the inner plate 14.

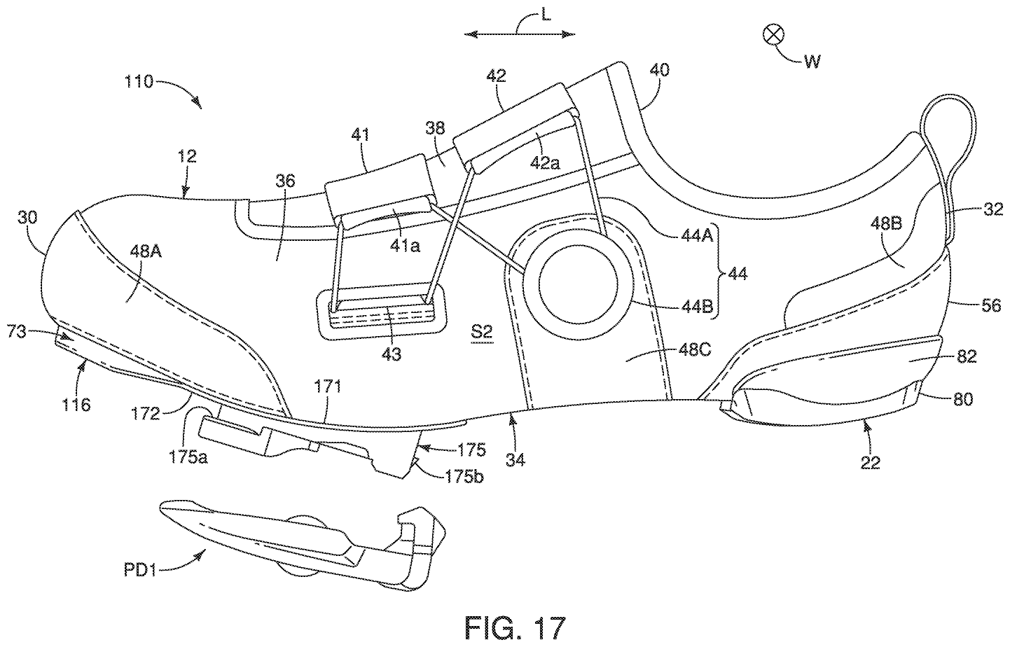

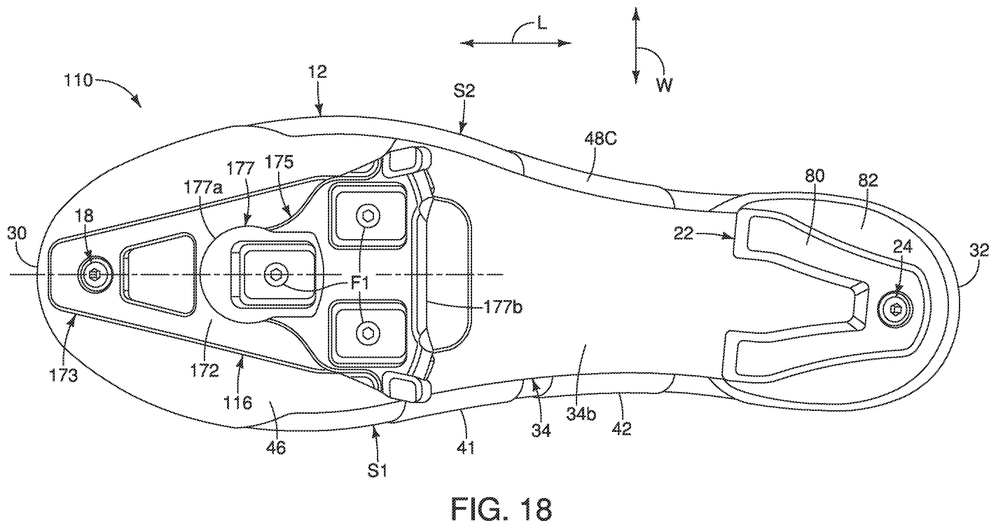

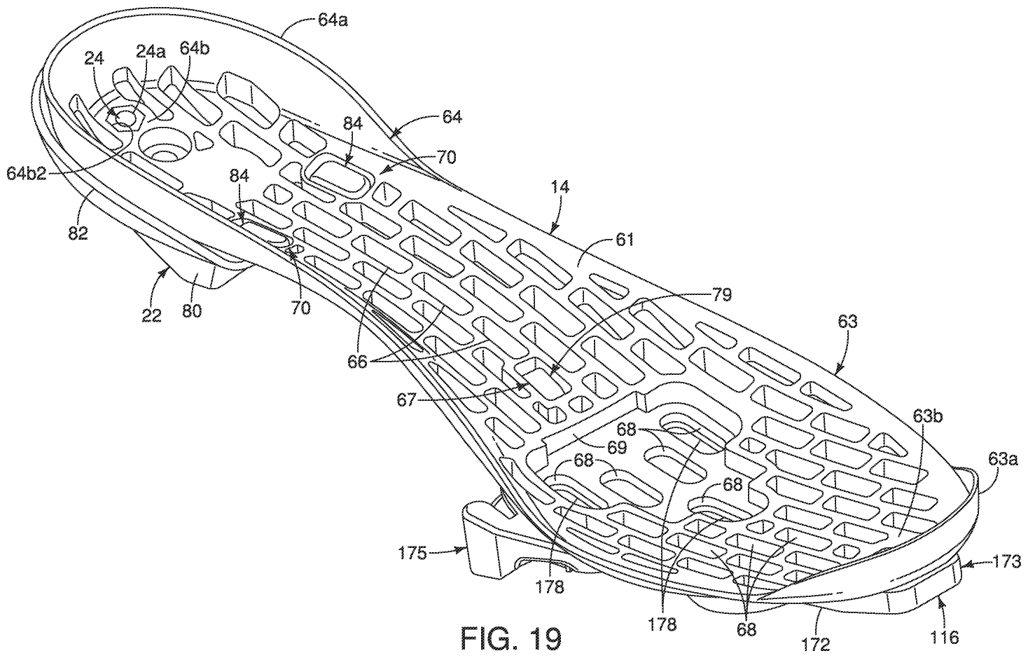

Referring now to FIGS. 17 to 21, a shoe 110 is illustrated in accordance with a second embodiment. In view of the similarity between the second embodiment and the first embodiment, the descriptions of the parts of the second embodiment that are identical to the parts of the first embodiment may be omitted for the sake of brevity. The shoe 110 basically comprises the upper 12 of the first embodiment, the inner plate 14 of the first embodiment and an outer plate 116. Also, the first coupling member 18 is used to fasten the inner plate 14 and the outer plate 116 together with the bottom portion 34 of the upper 12 disposed therebetween. The shoe 110 further comprises the heel pad 20 of the first embodiment. The heel pad 20 is attached to the inner plate 14 by the second coupling member 24 in the same manner as in the first embodiment. Here, in the second embodiment, the shoe 110 is identical to the shoe 10 of the first embodiment, except that the outer plate 16 of the first embodiment has been replaced with the outer plate 116.

Here, in the second embodiment, the outer plate 116 basically is identical to the outer plate 16 of the first embodiment, except that the outer plate 116 includes an integral cleat. Similar to the first embodiment, the outer plate 116 is a one-piece member that is constructed of a substantially rigid material. Here, the outer plate 116 includes a resin material. Preferably, the resin material of the outer plate 116 includes a polyamide material. Also, preferably, the resin material of the outer plate 116 also includes a fiber material. For example, the fiber material includes a plurality of carbon fibers. Thus, for example, the material of the outer plate 116 can be a polyamide material that is reinforced with carbon fibers. Alternatively, for example, the fiber material includes a plurality of glass fibers. Thus, for example, the material of the outer plate 116 can be a polyamide material that is reinforced with glass fibers. In other words, the material of the outer plate 116 can be a fiber reinforced plastic (FRP). By forming the outer plate 116 of a rigid resin material, the outer plate 116 will not deform (e.g., bend) during flexing of the shoe 110 such as during walking, jogging, running, etc.

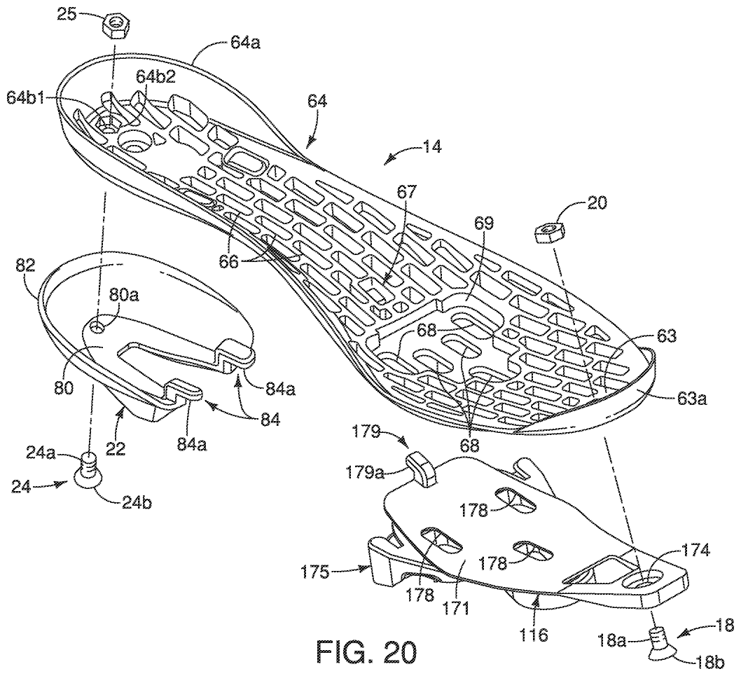

The outer plate 116 has an upper surface 171 and a bottom surface 172 that facings in the opposite direction to the upper surface 171. The outer plate 116 is disposed on the bottom side 34b of the bottom portion 34. In particular, the outer plate 116 is removably coupled to the bottom side 34b of the bottom portion 34 by the first coupling member 18. The outer plate 116 further comprises a second attachment portion 173. The second attachment portion 173 is configured to be disposed on the bottom side 34b of the bottom portion 34 of the upper 12. The second attachment portion 173 is attached to the inner plate 14 that is provided to the upper side of the bottom portion 34 in the same manner as the first embodiment. Here, the second attachment portion 173 includes an opening 174 as seen in FIG. 20. In this way, the outer plate 116 is removably coupled to the bottom side 34b of the bottom portion 34 by the first coupling member 18.

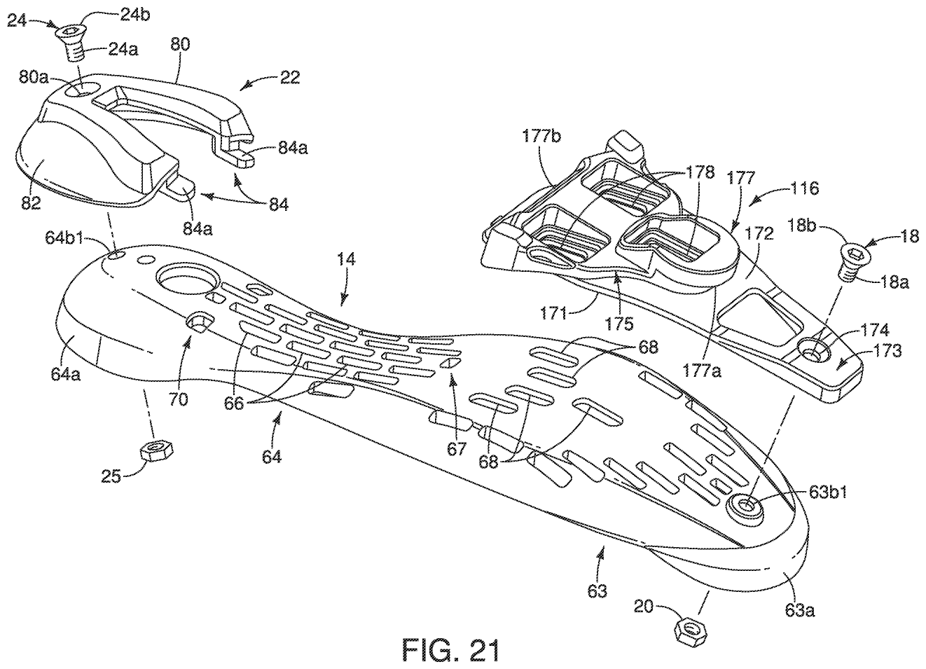

The outer plate 116 further comprises a contact portion 175. Basically, the contact portion 175 is configured as a cleat that is configured to contact the pedal PD1. Accordingly, the contact portion 175 can also be referred to a cleat portion 175. Of course, the shape of the contact portion 175 will depend on the type of pedal that is being used. Thus, the contact portion 175 can be configured as any type of cleat. Here, the contact portion 175 has the shape of cleat C1. The outer plate 116 has a pedal engagement portion 177. The pedal engagement portion 177 is configured to engage the step-in pedal PD1 (see FIG. 17). Here, the pedal engagement portion 177 is a part of contact portion 175. In the second embodiment, the pedal engagement portion 177 includes a front or first pedal engagement portion 177a and a rear or second pedal engagement portion 177b. In this second embodiment, the contact portion 175 includes a plurality of cleat attachment openings 178 as seen in FIGS. 20 and 21. In this way, the outer plate 116 is attached to the upper 12 and the inner plate 14 by the fasteners F1 in the same manner as the first embodiment.

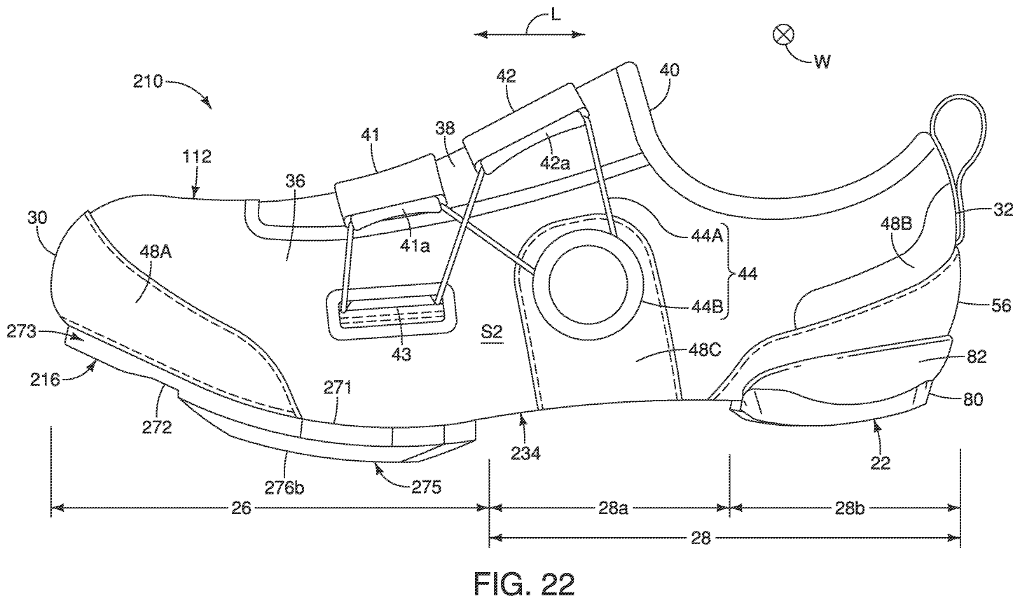

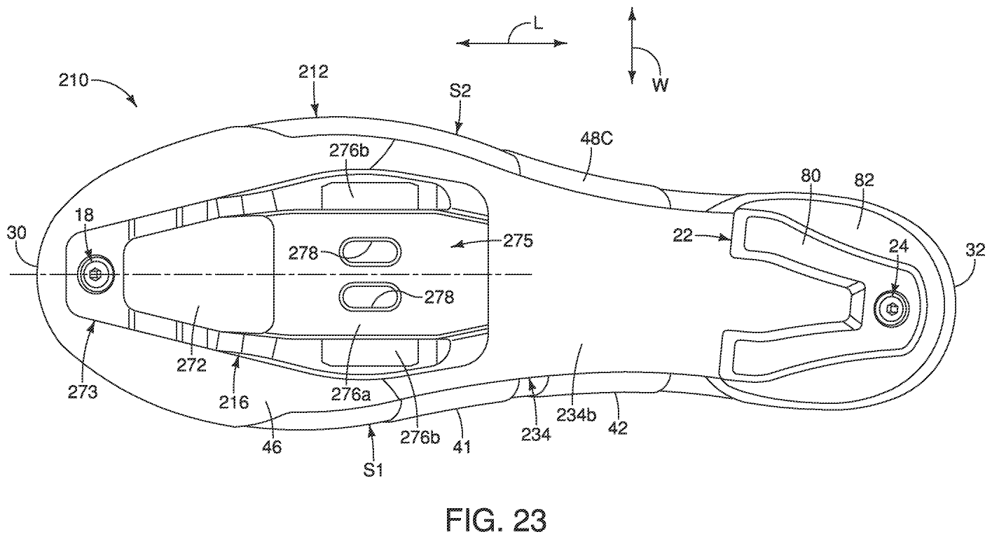

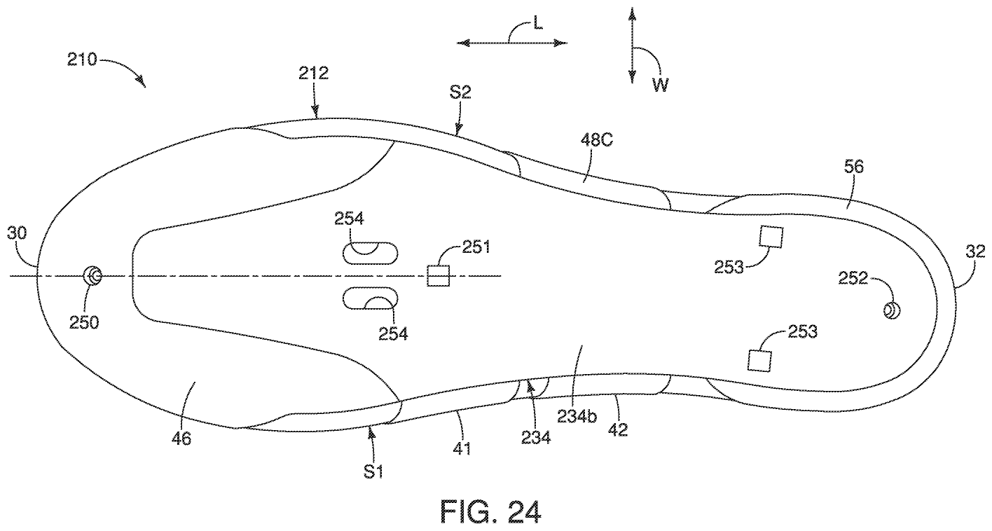

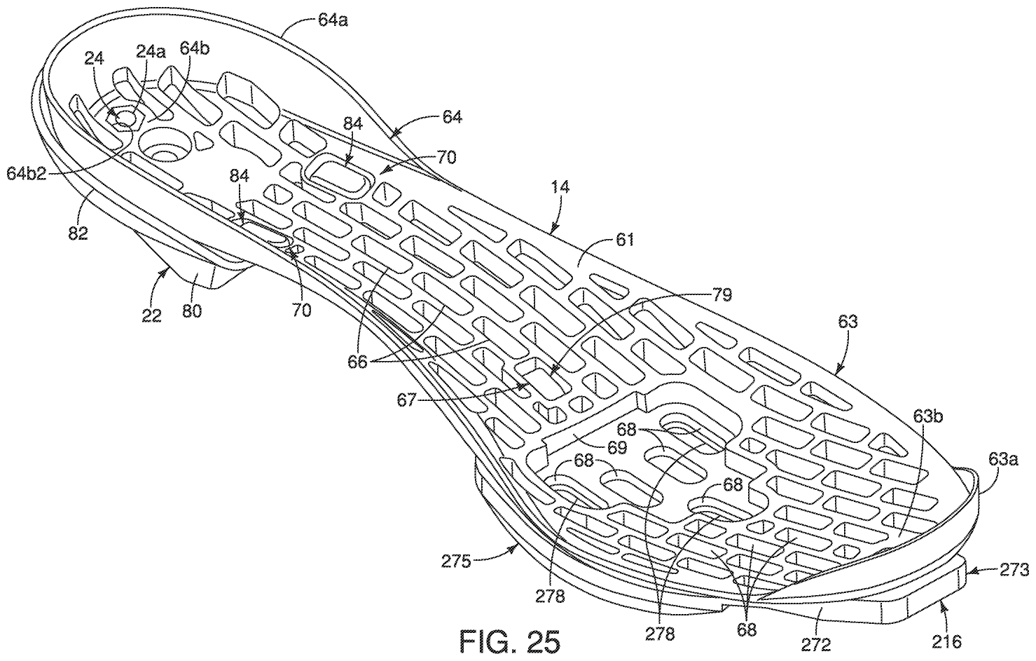

Referring now to FIGS. 22 to 28, a shoe 210 is illustrated in accordance with a third embodiment. In view of the similarity between the third embodiment and the prior embodiments, the descriptions of the parts of the third embodiment that are identical to the parts of the first embodiment may be omitted for the sake of brevity. The shoe 210 basically comprises an upper 212, the inner plate 14 of the first embodiment and an outer plate 216. Also, the first coupling member 18 is used to fasten the inner plate 14 and the outer plate 216 together with a bottom portion of the upper 212 disposed therebetween. The shoe 210 further comprises the heel pad 20 of the first embodiment. The heel pad 20 is attached to the inner plate 14 by the second coupling member 24 in the same manner as in the first embodiment. Here, in the third embodiment, the shoe 210 is identical to the shoe 10 of the first embodiment, except that the upper 12 of the first embodiment has been replaced with the upper 212 and that the outer plate 16 of the first embodiment has been replaced with the outer plate 216.

The upper 212 is identical to the upper 12 of the first embodiment, except that the bottom portion 34 has been replaced with a bottom portion 234. Thus, the parts of the upper 212 that are identical to the parts of the upper 12 will be given the same reference number. Thus, here, the body portion 36 is sewn to the bottom portion 234 in the same manner as in the first embodiment. The bottom portion 234 is identical to the bottom portion 34, except that the openings in the bottom portion 234 have been changed to accommodate the outer plate 216. For attaching the outer plate 216 to the upper 212 and the inner plate 14, the bottom portion 234 includes a through opening 250 which receives the first coupling member 18 therein in the same manner as in the first embodiment. Also, for attaching the outer plate 216 to the upper 212 and the inner plate 14, the bottom portion 234 includes a through opening 251 receives a portion of the outer plate 216 therethrough in the same manner as in the first embodiment.

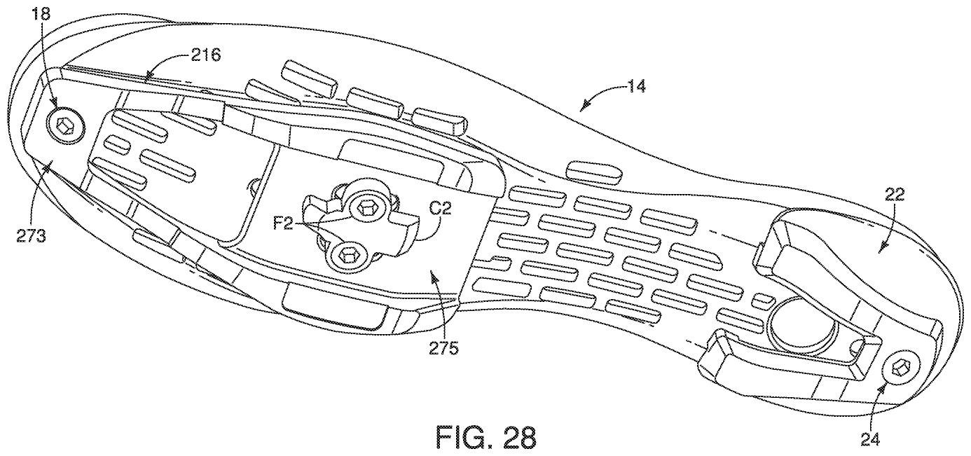

For attaching the heel pad 22 to the upper 212 and the inner plate 14, the bottom portion 234 includes a through opening 252 which receives the second coupling member 24 therein in the same manner as in the first embodiment. Also, for attaching the heel pad 22 to the upper 212 and the inner plate 14, the bottom portion 234 includes a pair of through openings 253 that each receives a portion of the outer plate 216 therethrough in the same manner as in the first embodiment. Finally, the bottom portion 234 includes a plurality of attachment openings 254 for fasteners F2 to attach a cleat C2 to the shoe 10 as seen in FIG. 28. Thus, in the third embodiment, the bottom portion 234 has fewer through openings for attaching the cleat C2 to the shoe 10.

Similar to the first embodiment, the outer plate 216 is a one-piece member that is constructed of a substantially rigid material. Here, the outer plate 216 includes a resin material. Preferably, the resin material of the outer plate 216 includes a polyamide material. Also, preferably, the resin material of the outer plate 216 also includes a fiber material. For example, the fiber material includes a plurality of carbon fibers. Thus, for example, the material of the outer plate 216 can be a polyamide material that is reinforced with carbon fibers. Alternatively, for example, the fiber material includes a plurality of glass fibers. Thus, for example, the material of the outer plate 216 can be a polyamide material that is reinforced with glass fibers. In other words, the material of the outer plate 216 can be a fiber reinforced plastic (FRP). By forming the outer plate 216 of a rigid resin material, the outer plate 216 will not deform (e.g., bend) during flexing of the shoe 210 such as during walking, jogging, running, etc.

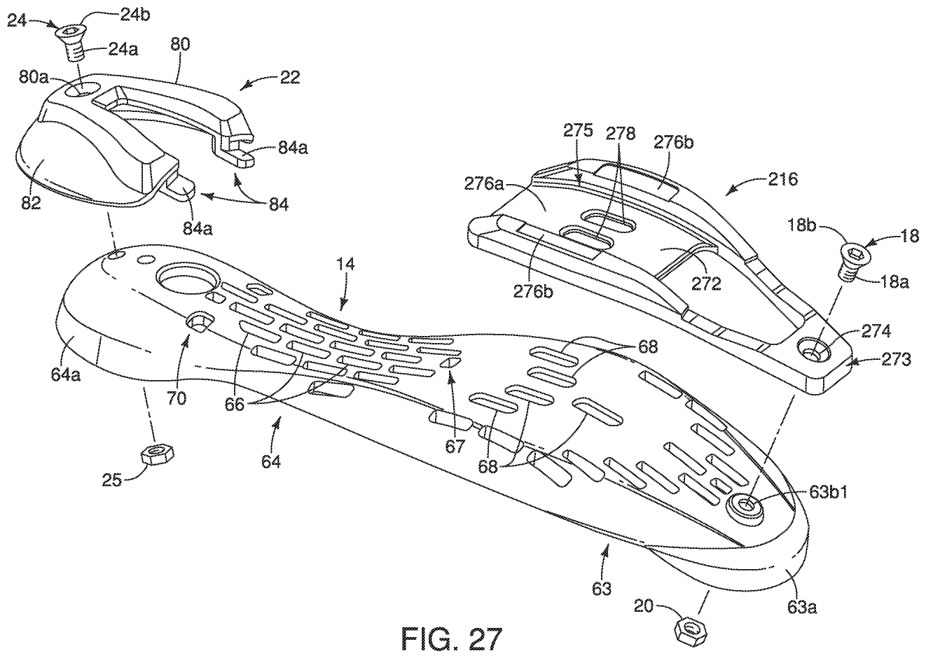

The outer plate 216 has an upper surface 271 and a bottom surface 272 that facings in the opposite direction to the upper surface 271. The outer plate 216 is disposed on a bottom side 234b of the bottom portion 234. In particular, the outer plate 116 is removably coupled to the bottom side 234b of the bottom portion 234 by the first coupling member 18. The outer plate 216 further comprises a second attachment portion 273. The second attachment portion 273 is configured to be disposed on the bottom side 234b of the bottom portion 234 of the upper 212. The second attachment portion 273 is attached to the inner plate 14 that is provided to the upper side of the bottom portion 234 in the same manner as the first embodiment. Here, the second attachment portion 273 includes an opening 274 as seen in FIG. 27. In this way, the outer plate 216 is removably coupled to the bottom side 234b of the bottom portion 234 by the first coupling member 18.

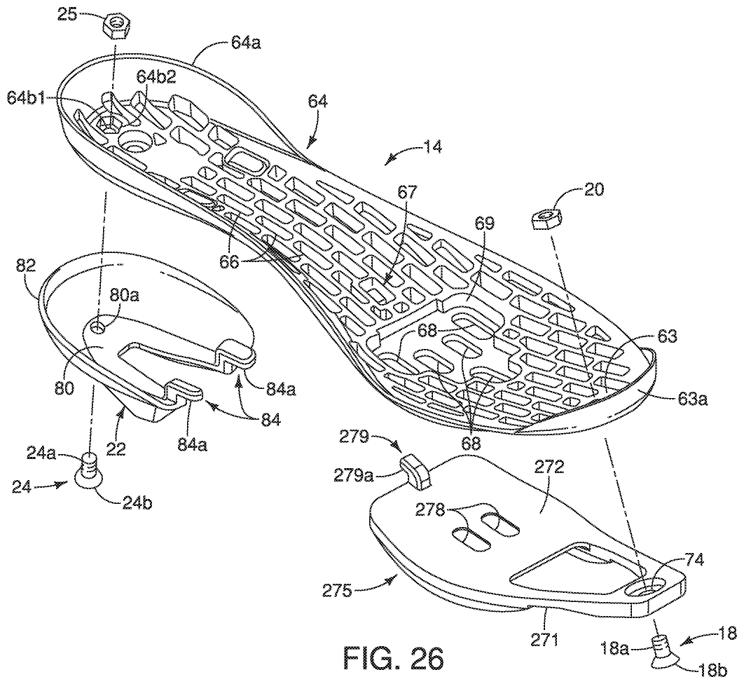

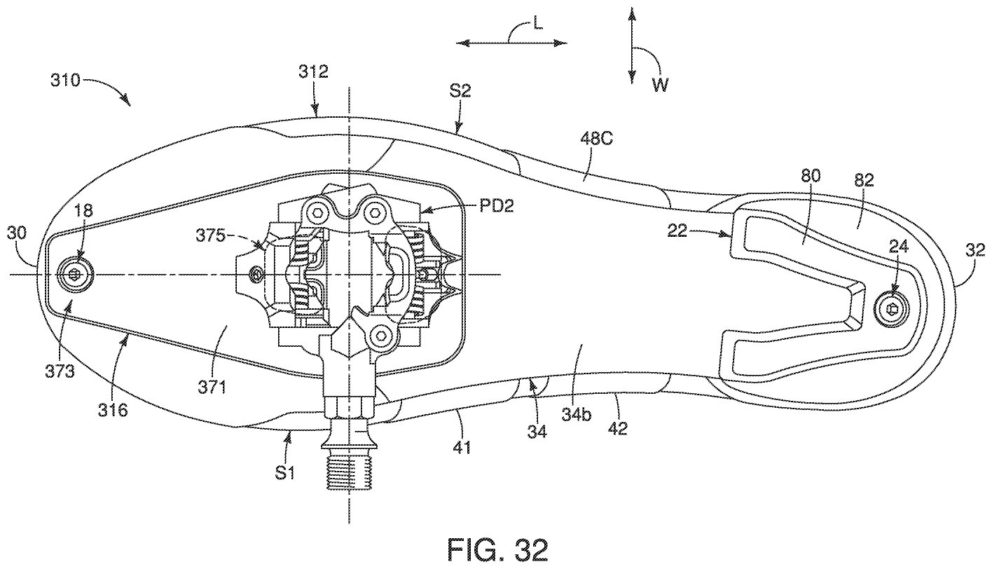

The outer plate 216 further comprises a contact portion 275. Basically, the contact portion 275 is configured to contact at least one of a cleat and a pedal. Here, the contact portion 275 includes a first contact surface 276a for contacting the cleat C2, and a pair of second contact surfaces 276b for contacting a step-in pedal (e.g., the pedal shown in FIG. 32). The first contact surface 276a is disposed between the second contact surfaces 276b with respect to the widthwise direction W as viewed from a bottom plan view of the shoe 210. In this third embodiment, the contact portion 275 includes and a pair of cleat attachment openings 278 as seen in FIGS. 26 and 27. In this way, the cleat C2 is attached to the upper 212, the inner plate 14 and the outer plate 216 by a pair of fasteners F2. The cleat attachment openings 278 are formed in the first contact surface 276a and disposed between the second contact surfaces 276b with respect to the widthwise direction W as viewed from a bottom plan view of the shoe 210.

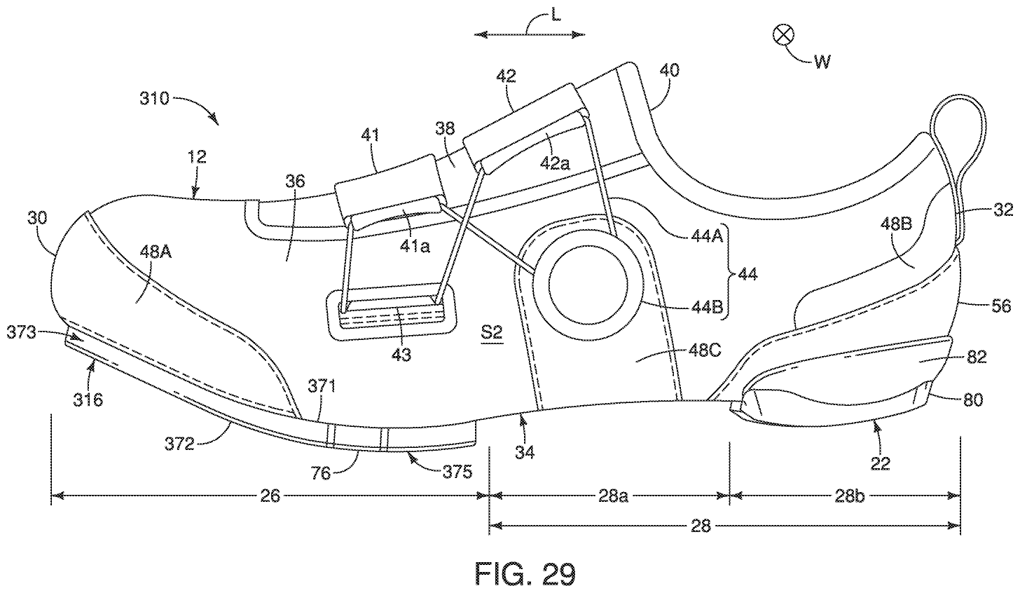

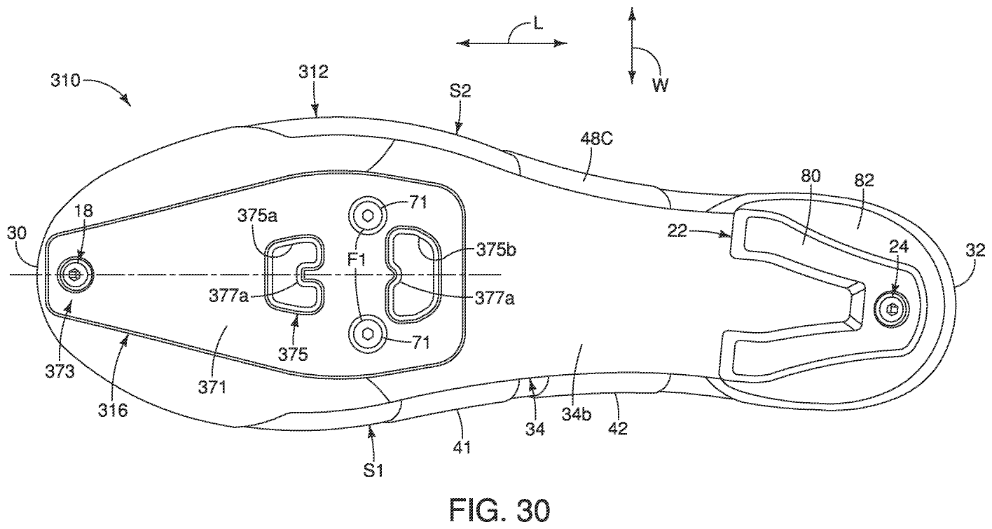

Referring now to FIGS. 29 to 32, a shoe 310 is illustrated in accordance with a fourth embodiment. In view of the similarity between the fourth embodiment and the prior embodiments, the descriptions of the parts of the fourth embodiment that are identical to the parts of the prior embodiments may be omitted for the sake of brevity. The shoe 310 basically comprises the upper 12 of the first embodiment, the inner plate 14 of the first embodiment and an outer plate 316. Also, the first coupling member 18 is used to fasten the inner plate 14 and the outer plate 316 together with a bottom portion of the upper 12 disposed therebetween. The shoe 310 further comprises the heel pad 20 of the first embodiment. The heel pad 20 is attached to the inner plate 14 by the second coupling member 24 in the same manner as in the first embodiment. Here, in the fourth embodiment, the shoe 310 is identical to the shoe 10 of the first embodiment, except that the outer plate 16 of the first embodiment has been replaced with the outer plate 316.

Here, in the fourth embodiment, the outer plate 316 includes an integral cleat. Similar to the first embodiment, the outer plate 316 is a one-piece member that is constructed of a substantially rigid material. Here, the outer plate 316 includes a resin material. Preferably, the resin material of the outer plate 316 includes a polyamide material. Also, preferably, the resin material of the outer plate 316 also includes a fiber material. For example, the fiber material includes a plurality of carbon fibers. Thus, for example, the material of the outer plate 316 can be a polyamide material that is reinforced with carbon fibers. Alternatively, for example, the fiber material includes a plurality of glass fibers. Thus, for example, the material of the outer plate 316 can be a polyamide material that is reinforced with glass fibers. In other words, the material of the outer plate 316 can be a fiber reinforced plastic (FRP). By forming the outer plate 316 of a rigid resin material, the outer plate 316 will not deform (e.g., bend) during flexing of the shoe 310 such as during walking, jogging, running, etc.

The outer plate 316 has an upper surface 371 and a bottom surface 372 that facings in the opposite direction to the upper surface 371. The outer plate 316 is disposed on the bottom side 34b of the bottom portion 34. In particular, the outer plate 316 is removably coupled to the bottom side 34b of the bottom portion 34 by the first coupling member 18. The outer plate 316 further comprises a second attachment portion 373. The second attachment portion 373 is configured to be disposed on the bottom side 34b of the bottom portion 34 of the upper 12. The second attachment portion 373 is attached to the inner plate 14 that is provided to the upper side of the bottom portion 34 in the same manner as the first embodiment. In this way, the outer plate 316 is removably coupled to the bottom side 34b of the bottom portion 34 by the first coupling member 18.

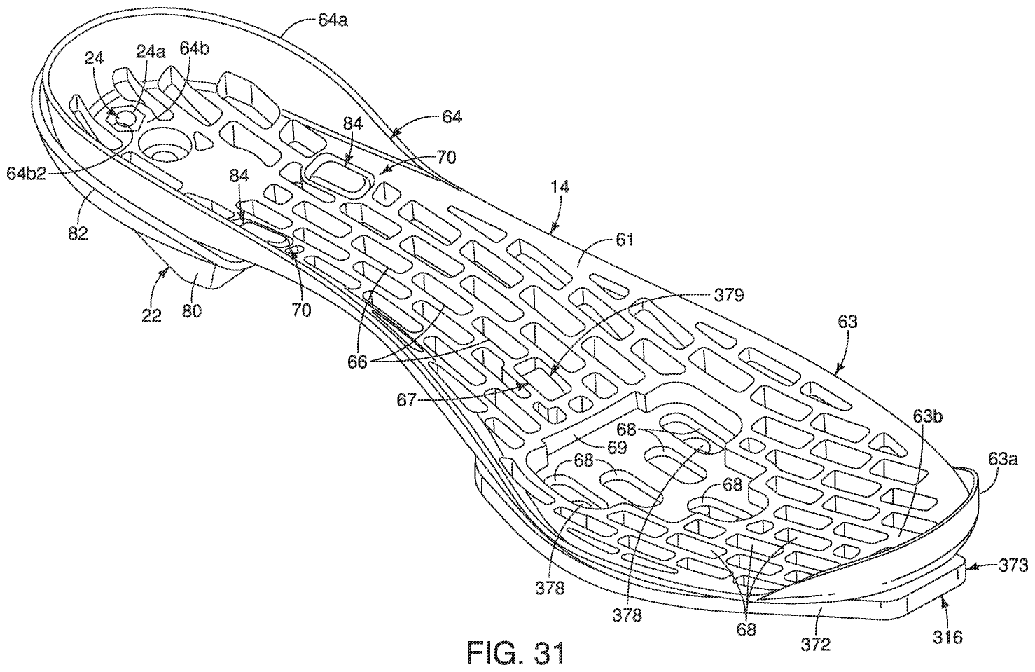

The outer plate 316 further comprises a contact portion 375. Basically, the contact portion 375 is configured as a cleat that is configured to contact the pedal PD2. Accordingly, the contact portion 375 can also be referred to a cleat portion 375. Of course, the shape of the contact portion 375 will depend on the type of pedal that is being used. Thus, the contact portion 375 can be configured as any type of cleat. In this fourth embodiment, the contact portion 375 includes a pair of cleat attachment openings 378 as seen in FIG. 31. In this way, the outer plate 316 is attached to the upper 12 and the inner plate 14 by a pair of the fasteners F1.

The outer plate 316 has a pedal engagement portion 377. The pedal engagement portion 377 is configured to engage the step-in pedal PD2 (see FIG. 32) in a conventional manner. Here, the pedal engagement portion 377 is a part of contact portion 375. In the fourth embodiment, the pedal engagement portion 377 includes a front or first pedal engagement portion 377a and a rear or second pedal engagement portion 377b. The contact portion 375 includes at least one recess that is configured to accommodate a cleat securing member of the step-in pedal PD2 therein. Here, the contact portion 375 includes a front or first recess 375a and a rear or second recess 375b that are configured to accommodate the cleat securing members of the step-in pedal PD2.

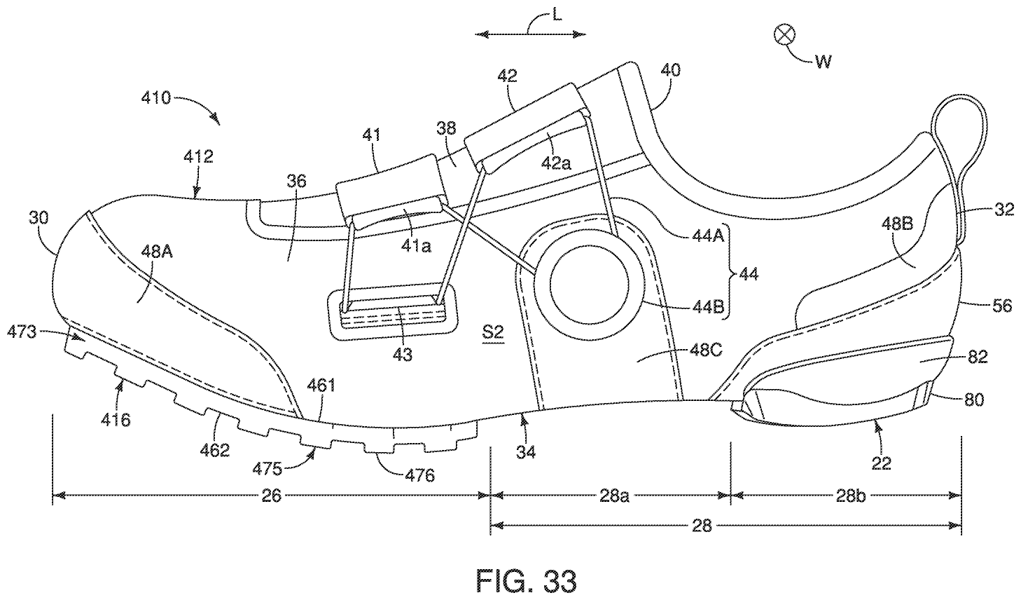

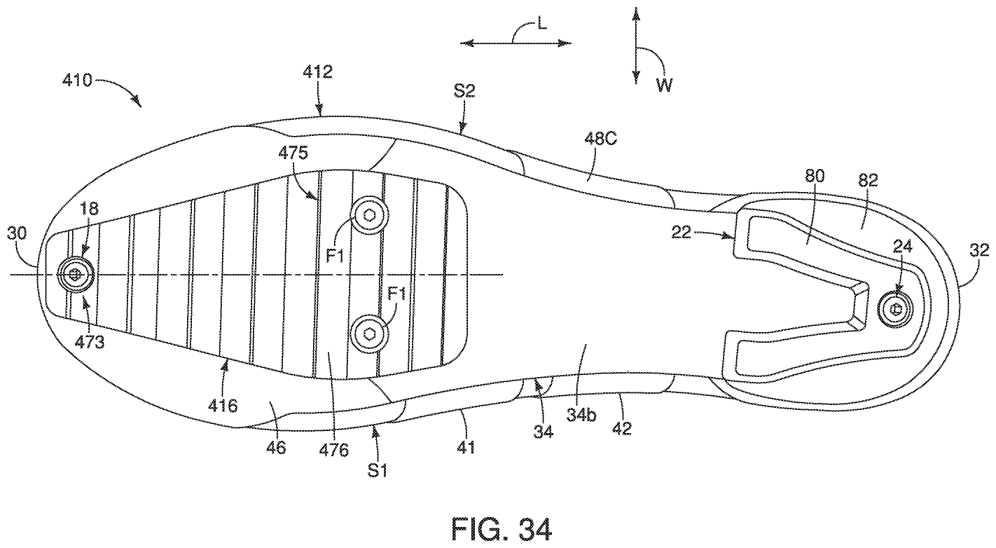

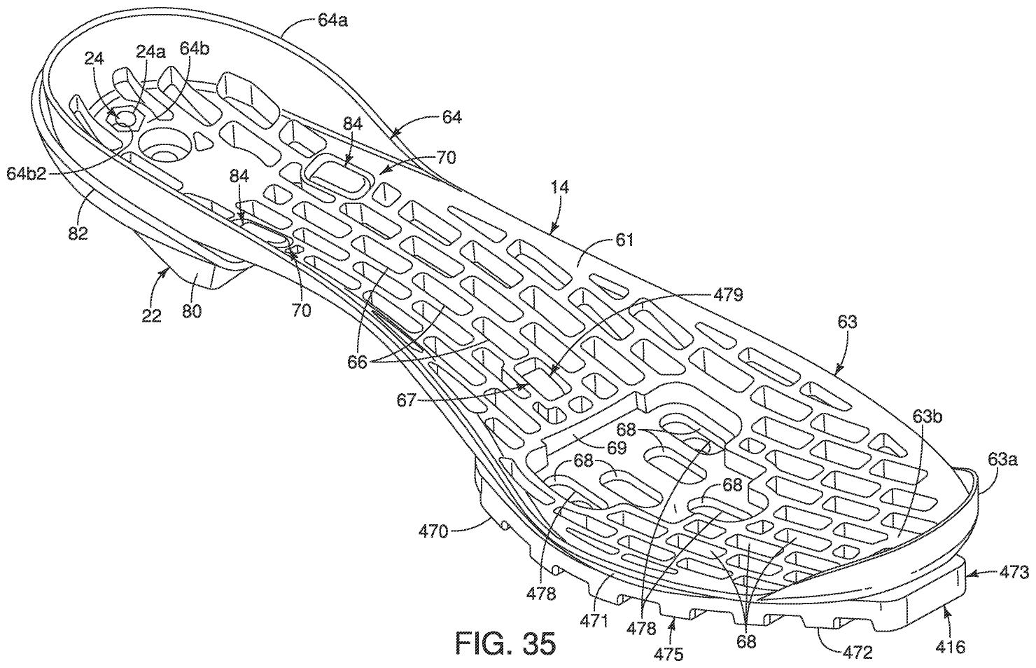

Referring now to FIGS. 33 to 37, a shoe 410 is illustrated in accordance with a fifth embodiment. In view of the similarity between the fifth embodiment and the prior embodiments, the descriptions of the parts of the fifth embodiment that are identical to the parts of the prior embodiments may be omitted for the sake of brevity. The shoe 410 basically comprises the upper 12 of the first embodiment, the inner plate 14 of the first embodiment and an outer plate 416. Also, the first coupling member 18 is used to fasten the inner plate 14 and the outer plate 416 together with a bottom portion of the upper 12 disposed therebetween. The shoe 410 further comprises the heel pad 20 of the first embodiment. The heel pad 20 is attached to the inner plate 14 by the second coupling member 24 in the same manner as in the first embodiment. Here, in the fifth embodiment, the shoe 410 is identical to the shoe 10 of the first embodiment, except that the outer plate 16 of the first embodiment has been replaced with the outer plate 416.

Here, in the fifth embodiment, the outer plate 416 is configured for use with a non-step-in pedal, and especially suitable for walking on the ground. Similar to the first embodiment, the outer plate 416 is a one-piece member. Here, the outer plate 416 is also preferably formed of a deformable material that can bend. Preferably, the material of the outer plate 416 is a different material than the material of the inner plate 14. For example, the outer plate 416 can be constructed from a rubber material. The rubber material of the outer plate 416 can be a natural rubber, a synthetic rubber or a blend of natural and synthetic rubbers. Here, the touter plate 416 includes an elastic polymer material such as synthetic rubber or polyurethane (e.g., a thermoplastic polyurethane). The outer plate 416 can be formed by injection molding. The outer plate 416 is attached to the upper 12 and the inner plate 14 in a similar manner as the prior embodiments.

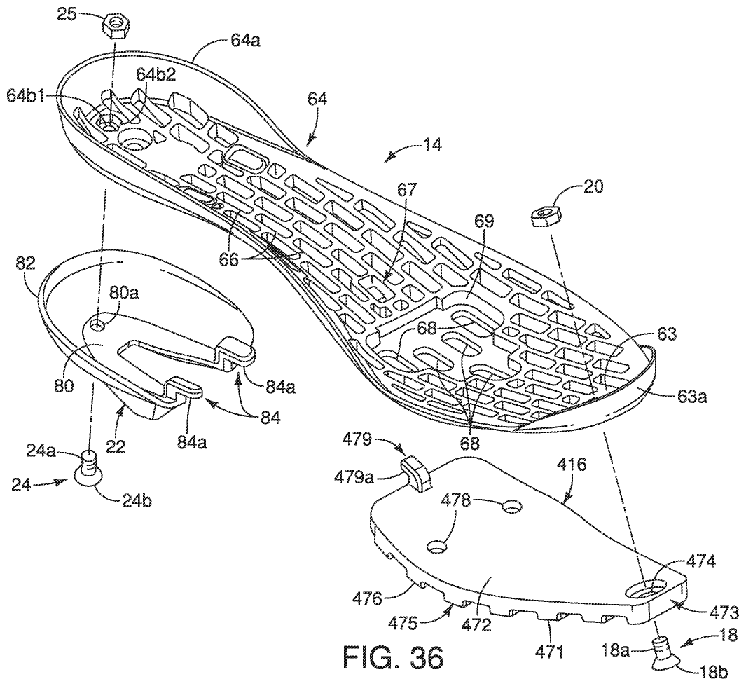

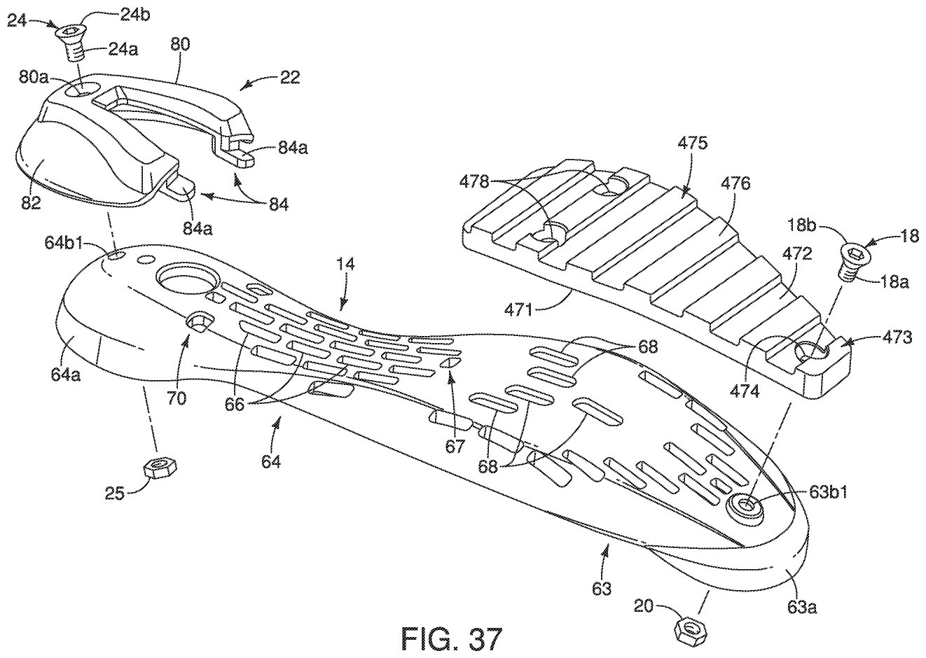

The outer plate 416 has an upper surface 471 and a bottom surface 472 that facings in the opposite direction to the upper surface 471. The outer plate 416 is disposed on the bottom side 34b of the bottom portion 34. In particular, the outer plate 416 is removably coupled to the bottom side 34b of the bottom portion 34 by the first coupling member 18. The outer plate 416 further comprises a second attachment portion 473. The second attachment portion 473 is configured to be disposed on the bottom side 34b of the bottom portion 34 of the upper 12. Here, the second attachment portion 473 includes an opening 474 as seen in FIG. 37. The second attachment portion 473 is attached to the inner plate 14 that is provided to the upper side of the bottom portion 34 in the same manner as the first embodiment. In this way, the outer plate 416 is removably coupled to the bottom side 34b of the bottom portion 34 by the first coupling member 18. The outer plate 416 further comprises a contact portion 475. The contact portion 475 includes a ground contact portion 476. The ground contact portion 476 preferably includes a tread to provide traction for the shoe sole 410 during use. In this fifth embodiment, the contact portion 475 includes and a pair of cleat attachment openings 478 as seen in FIGS. 36 and 37. In this way, the outer plate 216 is further securely attached to the upper 212 and the inner plate 14 by a pair of the fasteners F1.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts unless otherwise stated.

As used herein, the following directional terms “frame facing side”, “non-frame facing side”, “forward”, “rearward”, “front”, “rear”, “up”, “down”, “above”, “below”, “upward”, “downward”, “top”, “bottom”, “side”, “vertical”, “horizontal”, “perpendicular” and “transverse” as well as any other similar directional terms refer to those directions of a shoe in an upright, riding position and equipped with the shoe. Accordingly, these directional terms, as utilized to describe the shoe should be interpreted relative to a person wearing the shoe on a horizontal surface. The terms “left” and “right” are used to indicate the “right” when referencing from the right side as viewed from a person wearing the shoe, and the “left” when referencing from the left side as viewed from a person wearing the shoe.

The phrase “at least one of” as used in this disclosure means “one or more” of a desired choice. For one example, the phrase “at least one of” as used in this disclosure means “only one single choice” or “both of two choices” if the number of its choices is two. For another example, the phrase “at least one of” as used in this disclosure means “only one single choice” or “any combination of equal to or more than two choices” if the number of its choices is equal to or more than three. Also, the term “and/or” as used in this disclosure means “either one or both of”. For instance, the phrase “at least one of A and B” encompasses (1) A alone, (2), B alone, and (3) both A and B. The phrase “at least one of A, B, and C” encompasses (1) A alone, (2), B alone, (3) C alone, (4) both A and B. (5) both B and C, (6) both A and C, and (7) all A, B, and C. In other words, the phrase “at least one of A and B” does not mean “at least one of A and at least one of B” in this disclosure.

Also, it will be understood that although the terms “first” and “second” may be used herein to describe various components, these components should not be limited by these terms. These terms are only used to distinguish one component from another. Thus, for example, a first component discussed above could be termed a second component and vice versa without departing from the teachings of the present invention.

The term “attached” or “attaching”, as used herein, encompasses configurations in which an element is directly secured to another element by affixing the element directly to the other element; configurations in which the element is indirectly secured to the other element by affixing the element to the intermediate member(s) which in turn are affixed to the other element; and configurations in which one element is integral with another element, i.e. one element is essentially part of the other element. This definition also applies to words of similar meaning, for example, “joined”, “connected”, “coupled”, “mounted”, “bonded”, “fixed” and their derivatives. Finally, terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, unless specifically stated otherwise, the size, shape, location or orientation of the various components can be changed as needed and/or desired so long as the changes do not substantially affect their intended function. Unless specifically stated otherwise, components that are shown directly connected or contacting each other can have intermediate structures disposed between them so long as the changes do not substantially affect their intended function. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A shoe comprising:
an upper having a toe end, a heel end and a bottom portion extending between the toe end and the heel end in a longitudinal direction;
an inner plate removably disposed on an upper side of the bottom portion;
an outer plate having a contact portion configured to contact at least one of a cleat and a pedal, the outer plate being disposed on a bottom side of the bottom portion; and
a first coupling member configured to couple the inner plate and the outer plate.

2. The shoe according to claim 1, wherein
the outer plate includes an opening for receiving the first coupling member.

3. The shoe according to claim 1, wherein
the bottom portion includes a through opening which receives the first coupling member therein.

4. The shoe according to claim 1, wherein
the first coupling member includes a male screw portion, and
the inner plate has a female screw portion threadedly engaged with the male screw portion therein.

5. The shoe according to claim 1, wherein
the contact portion includes a ground contact portion.

6. The shoe according to claim 1, wherein
the contact portion includes at least one recess configured to accommodate a cleat securing member of a step-in pedal therein.

7. A shoe comprising:
an upper having a toe end, a heel end and a bottom portion extending between the toe end and the heel end in a longitudinal direction;
an inner plate removably disposed on an upper side of the bottom portion;
an outer plate having a pedal engagement portion configured to engage a step-in pedal, the outer plate being disposed on a bottom side of the bottom portion; and
a first coupling member configured to couple the inner plate and the outer plate.

8. The shoe according to claim 1, wherein
the inner plate includes an air ventilation portion.

9. The shoe according to claim 8, wherein
the air ventilation portion includes a plurality of air ventilation openings.

10. The shoe according to claim 1, further comprising
a heel pad coupled to a rear end portion of the inner plate.

11. The shoe according to claim 10, further comprising
a second coupling member configured to couple the inner plate and the heel pad.

12. The shoe according to claim 1, wherein
the bottom portion includes a breathable material.

13. The shoe according to claim 12, wherein
the breathable material includes a mesh material.

14. The shoe according to claim 1, wherein
the inner plate includes a first engagement portion, and
the outer plate includes a second engagement portion engaged with the first engagement portion.

15. The shoe according to claim 1, wherein
the inner plate further having a heel support portion disposed on a rear end portion of the inner plate.

16. The shoe according to claim 1, further comprising
a heel cup disposed on the heel end.

17. An inner plate for a shoe having an upper, the inner plate comprising:
a forefoot part including a first attachment portion configured to be coupled to an outer plate provided to a bottom side on the upper;
a hindfoot part located rearward of the forefoot part and integrally formed with the forefoot part; and
a heel pad configured to be attached to the hindfoot part and projecting from a bottom surface of the hindfoot part,
the inner plate being configured removably disposed on an upper side of a bottom portion of the upper.

18. An outer plate for a shoe having an upper, the outer plate comprising:
a second attachment portion configured to be disposed on a bottom side of a bottom portion of the upper and attached to an inner plate provided to an upper side of the bottom portion; and
a contact portion configured to contact at least one of a cleat and a pedal.

19. The outer plate according to claim 18, wherein
the contact surface includes a ground contact portion.

20. The outer plate according to claim 18, wherein
the contact surface includes at least one recess configured to accommodate a cleat securing member of a step-in pedal therein.
